(19) United States
(12) Patent Application Publication
(10) Pub. No.: US 2017/0004718 A1
(43) Pub. Date: Jan. 5, 2017

(54) Mobile-Based Educational Learning Delivery And Assessment Systems And Methods

(71) Applicant: IQ INNOVATIONS, LLC, Columbus, OH (US)

(72) Inventors: Scott William Kern, Hilliard, OH (US); John Choi, Blacklick, OH (US)

(21) Appl. No.: 15/039,432

(22) PCT Filed: Mar. 6, 2014
(86) PCT No.: PCT/US14/21026

§ 371 Date: May 26, 2016

Related U.S. Application Data
(60) Provisional application No. 61/910,226, filed on Nov. 29, 2013.

(51) Int. Cl. G09B 5/12; G09B 7/00

(52) U.S. Cl. CPC G09B 5/125; G09B 7/00

(57) ABSTRACT

Systems and methods are provided for synchronizing educational multimedia content objects between a server system and a plurality of remote mobile communication devices over a network. An educational multimedia repository stores the educational multimedia content objects and makes the educational multimedia content objects accessible to software components operating within the educational multimedia system. The system downloads to one of the remote communication devices one or more of the educational multimedia content objects from the repository while the one of the remote communication devices has a data connection with the computer server system.

### CROSS-REFERENCE TO RELATED APPLICATIONS

The present application claims priority from U.S. Provisional Application Ser. No. 61/910,226 entitled “Mobile-Based Educational Learning Delivery And Assessment Systems And Methods,” filed 29 Nov. 2013, the entirety of which is hereby incorporated by reference.

### FIELD

This document relates generally to processor-implemented systems and methods for mobile-based educational learning delivery and assessment and more particularly to mobile-based educational learning delivery and assessment tools with a blended school aspect.

### BACKGROUND

The use of portable computing devices, such as laptops, tablet computers, smart phones, and other mobile devices has provided an opportunity for learning outside of the classroom. While Internet connectivity can make enormous amounts of educational data available to students, a gap in the availability of continuous Internet connectivity can be a disadvantage some students.

### SUMMARY

Systems and methods are provided for synchronizing educational multimedia content objects between a server system and a plurality of remote mobile communication devices over a network. An educational multimedia repository stores the educational multimedia content objects and makes the educational multimedia content objects accessible to software components operating within the educational multimedia system. Instructions, executing on the computer server system, download to one of the remote communication devices one or more of the educational multimedia content objects from the repository while the one of the remote communication devices has a data connection with the computer server system. Other instructions analyze educational content interdependencies that exist for a file to be downloaded to identify additional content to be downloaded to a specific remote mobile communication device for offline consumption.

As another example, a computer-implemented method of synchronizing educational multimedia content objects between a server system and a plurality of remote mobile communication devices over a network includes steps where one or more educational multimedia content objects are downloaded to one of a plurality of remote communication devices from an educational multimedia repository provided on one or more non-transitory computer-readable mediums of a computer server system, where the downloading occurs while the one of the remote communication devices has a data connection with the computer server system. The downloading includes determining which of the educational multimedia content objects are to be downloaded to a specific remote mobile communication device based upon an educational standard or a teacher preference. The downloading further includes analyzing educational content interdependencies that exist for a file to be downloaded to the specific remote mobile communication device to identify additional content to download for offline consumption, said analyzing being based on an educational standard, a teacher preference, or external related content required by the file to operate on the specific remote mobile communication device while the specific remote mobile communication device is offline.

### BRIEF DESCRIPTION OF THE DRAWINGS

FIG. 1 is a block diagram depicting a processor-implemented educational multimedia system.

FIG. 2 is a diagram depicting example relationships among entities of a hybrid learning system.

FIG. 3 is a diagram depicting additional entities of a learning management system.

FIG. 4 is a flow diagram depicting example operations of a learning management system.

FIG. 5 is a diagram depicting performance of certain steps by operators utilizing a learning management system.

FIG. 6 is a flow diagram illustrating a scenario within which an educator can select multimedia content for delivery and use by a student on the student's mobile device.

FIG. 7 is a flow diagram illustrating example processing performed when a student has finished his or her assignments when the device is online.

FIG. 8 is a flow diagram that describes additional example synchronization operations involving educational multimedia objects.

FIGS. 9-37 depict example graphical user interfaces for providing content via a learning management system.

FIG. 38 is a flow diagram depicting a computer-implemented method of synchronizing educational multimedia content objects between a server system and a plurality of remote mobile communication devices over a network.

### DETAILED DESCRIPTION

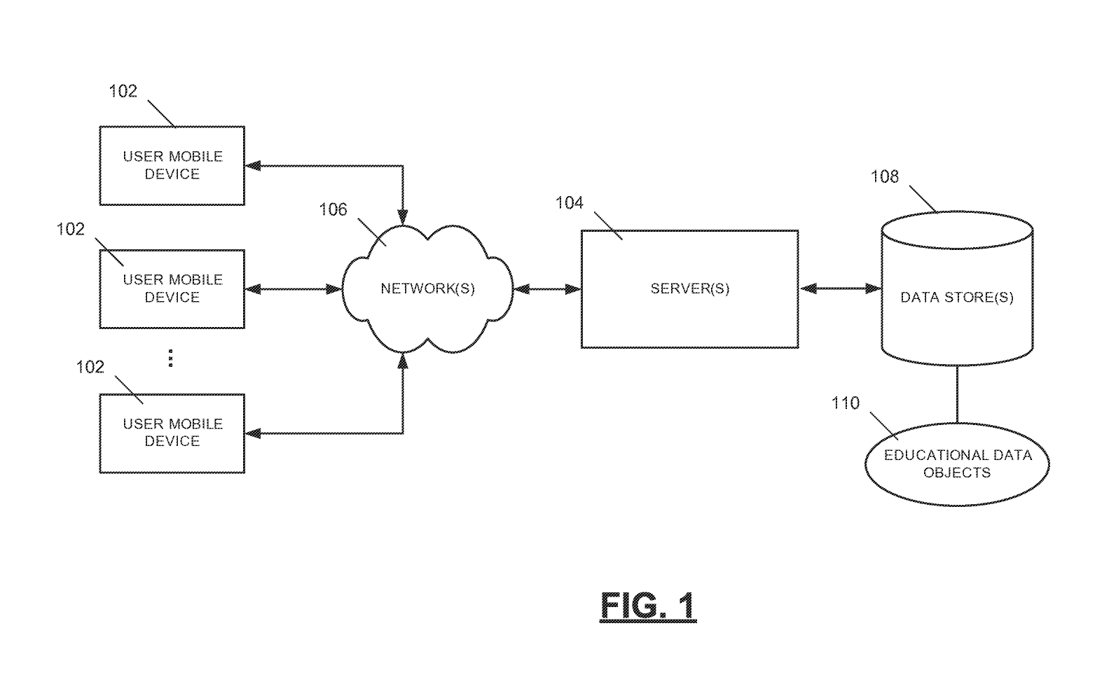

FIG. 1 is a block diagram depicting a processor-implemented educational multimedia system. FIG. 1 depicts a processor-based environment where users operating mobile devices 102 (e.g., tablets, smart phones, etc.) can use a hybrid learning system operating on one or more servers 104 via a network 106 that includes a mobile learning delivery and assessment tool. Operating on the one or more servers 104, the tool provides a student with seamless access to an educational technical platform that includes a content repository on one or more computer-readable data stores 108 containing educational data objects 110 that are accessible to a learning management system and an assessment engine operating on the one or more servers 104. The hybrid technology bridges use cases across student locations with and without Internet connectivity seamlessly. The system can be utilized in a blended school environment where students are tasked with learning activities both in and out of school or entirely out of a physical school building (e.g., distance learning).

The hybrid learning system of FIG. 1 can include educational content control as well as learning management systems that allow teachers to assign learning material to students based on unique needs of individual students and class dynamics. A hybrid learning system can further include synchronization processes so that educational content can be synched to a student's mobile device when the student is connected to Wi-Fi but also allows a student to access his or her personalized educational multimedia content on their mobile device without having a network connection.

The synchronization processes update learning content, assignments, quizzes, and assessments. With content available irrespective of being connected within a hybrid learning system, the connection barrier is removed, thereby freeing the student to work offline when needed in social scenarios and areas where an Internet connection may not be available such as at home. For example, this embodiment could be advantageous for schools which provide mobile equipment in that students with a hybrid learning system would have equal access to educational content regardless of their financial ability to provide Internet connectivity at home thus helping to bridge the digital divide.

The synchronization processes not only allow a student to complete their work while offline, but they can also see assessments and assignments that are due via multiple views, receive reminders about work due that day or work that is past due, track their progress with an intuitive visual guide, receive badges for work completed, and receive help for features within the mobile application.

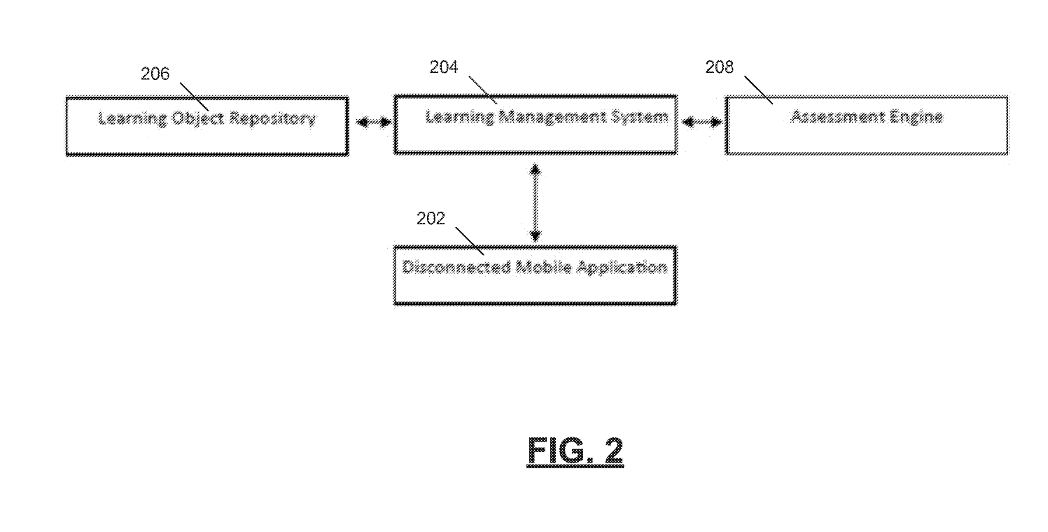

FIG. 2 is a diagram depicting example interconnections among components of a hybrid learning system. FIG. 2 depicts a disconnected mobile application that resides on the mobile device as well as the learning management system 204, a learning object repository 206, and assessment engine 208 which reside on one or more servers.

In one embodiment, the learning management platform includes a learning management system (iQity) 204 and learning object repository (Reactor) 206 that can be cloud-based. The disconnected mobile application 202 bridges the user experience for students across locations with and without Internet connectivity. This approach can ensure that content rendering, student activity, and functionality is seamlessly synchronized from the cloud-based platform to tablet or other mobile computing device. Functionality related to multiple file storage types (e.g., static, interactive, rich-media, video, audio), application association, and rendering are gracefully adapted from traditional desktop usage to a mobile device.

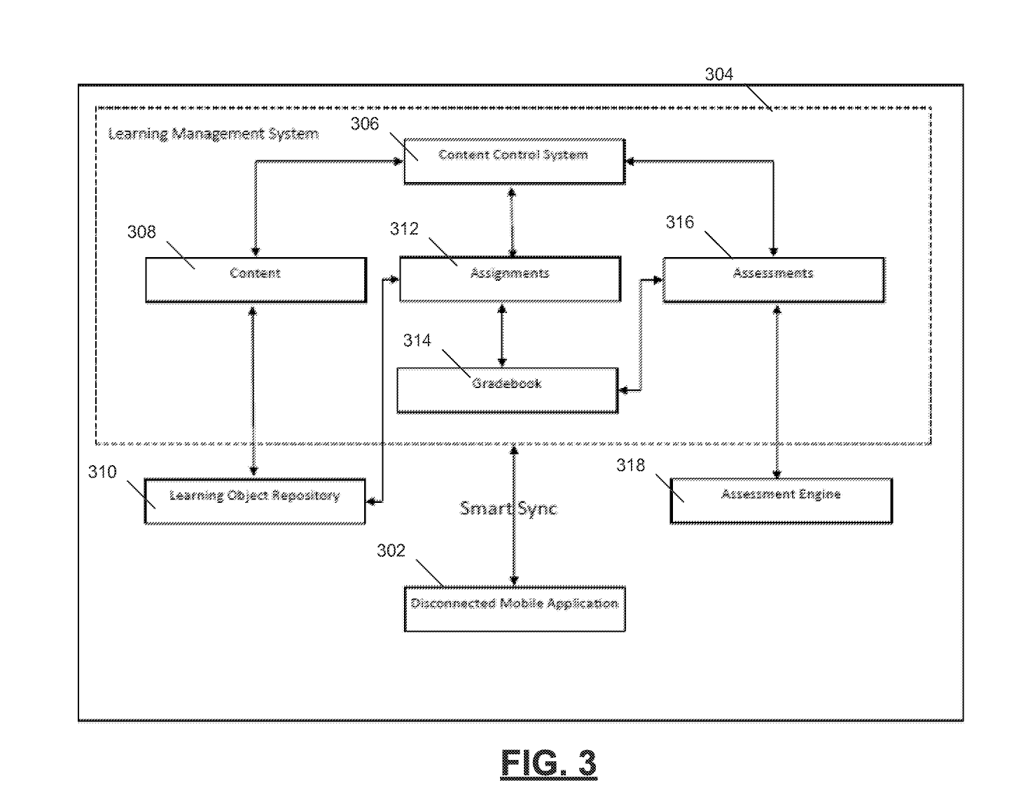

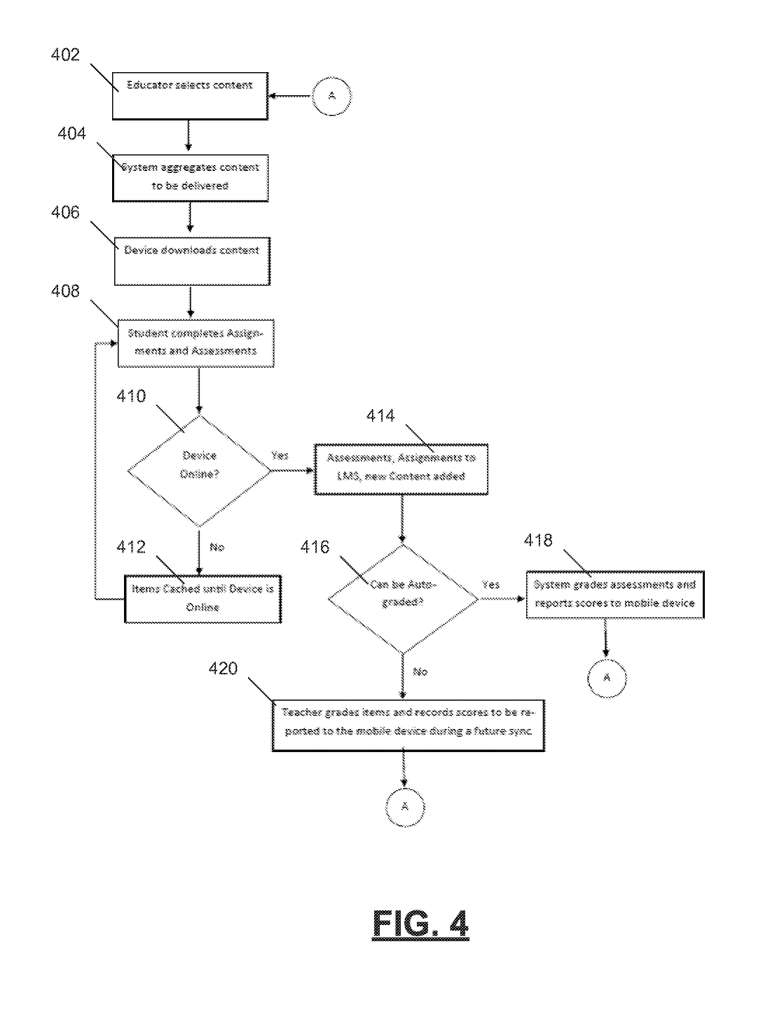

FIG. 3 is a diagram depicting additional components of a learning management system. When a disconnected mobile application 302 is accessed without Internet connection, student activity, assignments completed, quizzes/test, activity within system, supplemental materials accessed, etc. are stored locally to be synchronized at the next online opportunity for teacher review, data processing, and analytics. A learning management system 304 includes a content control system 306 that controls content 308 accessed from a learning object repository 310. The content control system 306 manages assignments 312 that can be configured to access content from the learning object repository 310, and student progress and achievement on assignments can be tracked in a gradebook 314. The content control system 306 further manages assessments 316 that are provided by and/or graded by an assessment engine 318, which may be internal or external to the learning management system 314.

FIG. 4 is a flow diagram depicting example operations of a learning management system. In the learning management system, a teacher can select the content at 402 from the lessons in the class that they want to be made available to the students. This allows a teacher to not only control what content is seen next but what content is academically appropriate for which groups of students. The system reviews the standards of the content selected by the teacher and compiles other content from the learning object repository that is aligned to similar or related standards.

At 404, the system aggregates the content to be delivered, and during the synchronization process, the correct content for that student at that time is downloaded at 406 to the mobile device. The system may also check the content before it is downloaded for DRM (digital rights management) compliance.

While offline or online, the student is able to read content and complete assignments and assessments at 408. The content can be highly interactive and contain audio, video, manipulatives, PDF's, HTML, etc. Once a student has completed assignments and assessments, these can be uploaded to the learning management system if the system is online. At 410, a check is performed to determine if the device is online. If the mobile device is not online, this information is cached at 412 on the device to be synchronized when online. If the mobile device is online, the items are uploaded and any new content is added for the student at 414. If the items can be auto-graded by the learning management system based on a determination at 416, the results of the assessment are made available to the student via the mobile device at 418. Those items that must be graded by a teacher will be reported to the mobile device during a future synchronization operation after grading by the teacher at 420. The student can continue operating the device, as indicated by the loops back to the start of the flow diagram at A.

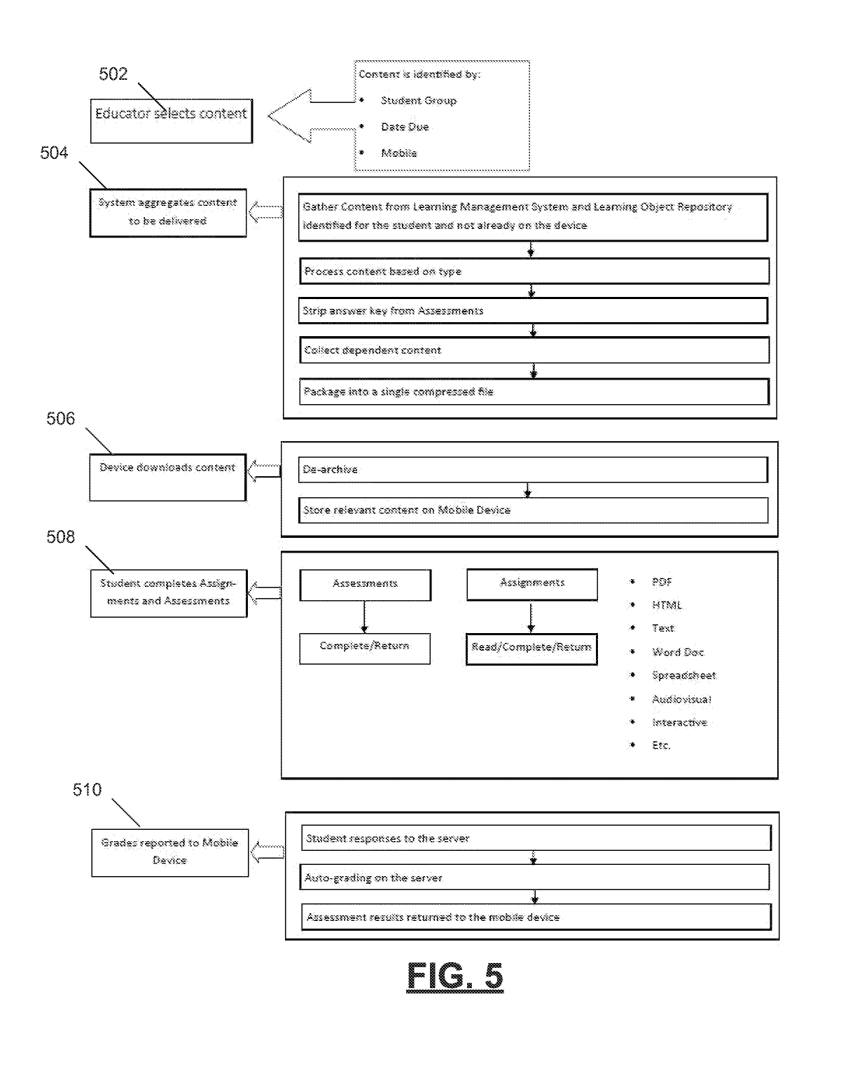

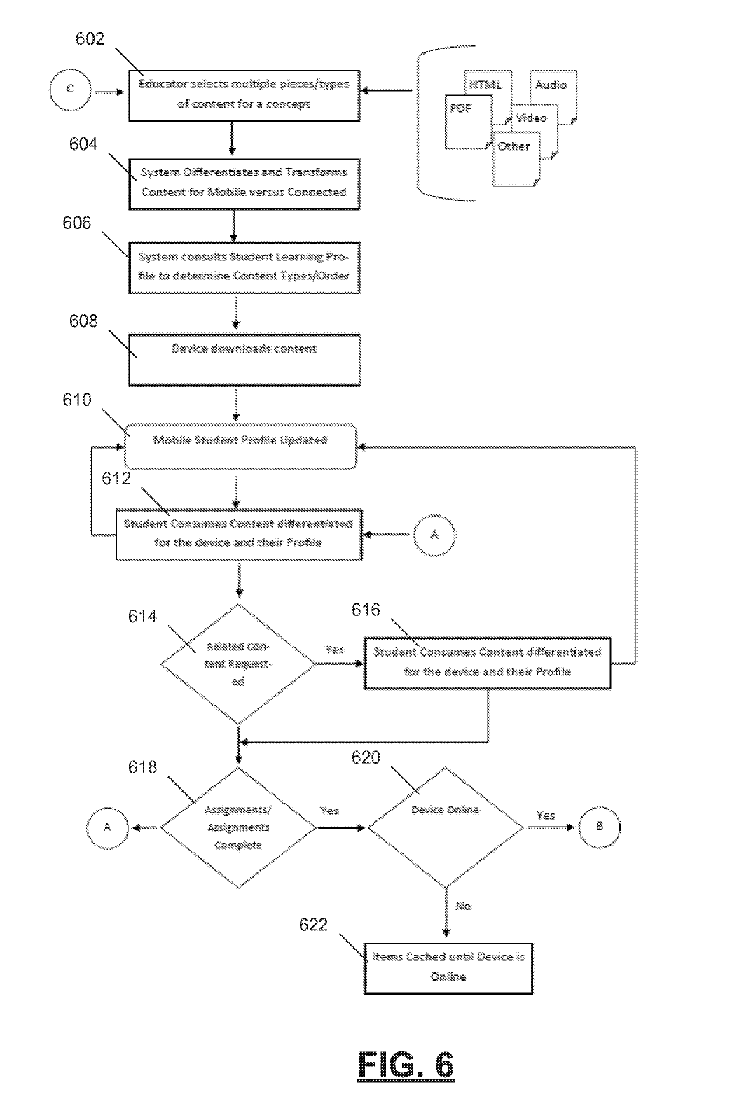

FIG. 5 is a diagram depicting performance of certain steps by operators utilizing a learning management system. At 502, an educator selects content, wherein content can be identified for specific student groups, by due date, and if it is specifically available for mobile devices.

At 504, the system can also aggregate complementary content for delivery to a mobile device. At this step in the process, content that has been identified for the student and which does not already reside on the mobile device is gathered from the learning management system and learning object repository including the downloading of HTML content, traversing the HTML document and gathering all the related links, downloading documents for all related links into the same directory as the HTML document, and further traversing the HTML document and replacing all related links to use the root directory of HTML. The content is processed based on type (data transformations where necessary), answer keys are removed from assessments, any dependent or related content is identified and collected, and this is packaged into a compressed file.

At 506, the device downloads content. The compressed file is de-archived and relevant content is stored on the mobile device. A student can complete assignments and assessments both online and while offline at 508.

At 510, grades are reported to a mobile device. Student responses to assessments and assignments are sent to the learning management system. In one embodiment, grading is completed on the server, not on the mobile device because answers do not appear with the assessments. Where auto-grading cannot occur, results for those items are returned to the mobile device in the first sync after they are manually graded; otherwise results are immediately available after sync. A student can monitor their progress within the application on the mobile device.

FIG. 6 is a flow diagram illustrating a scenario within which an educator can select multimedia content for delivery and use by a student on the student's mobile device. In this scenario, an educator selects multiple pieces/types of content for a particular concept (e.g., a lesson on a particular chemistry topic, etc.) at 602. The educator has a wide variety of content types that can be used and packaged, such as PDF files, HTML files, audio files, video files, and others.

At 604, the system differentiates and transforms the content for the mobile device based upon whether the content would be affected if the mobile device is off-line. The system also analyzes the student's learning profile at 606 in order to determine the content types and order. The learner profile is used to recommend core and alternate content based on individual student variables (e.g., mode of learning, effective content types, past successes, past failures, etc). This approach establishes an individualized student learning plan than seamlessly spans cloud-based learning platform to mobile devices.

The mobile device initiates the download of the content from the remote server during a period when it has connectivity at 608. The mobile student profile is updated at 610 on the mobile device to reflect the downloaded content. The student consumes the content that is differentiated for the device and the student's profile at 612. In other words, each student can receive different content based upon their unique profile. This can result in different content synchronization demands for the system.

If a student requests related content at 614, then the student consumes content that is differentiated for the device and their profile at 616. This results in the mobile student profile being updated. If a student has not requested related content at 614, then the system inquires whether the student has completed his or her assignment at 618. If not, processing resumes at the student content consumption step, as indicated by continuation marker “A.” However, if a student has completed his or her assignments at 618 and if the device is online at 620, processing continues as indicated by continuation marker “B.” If the device is off-line, then the items are cached until the device is online at 622.

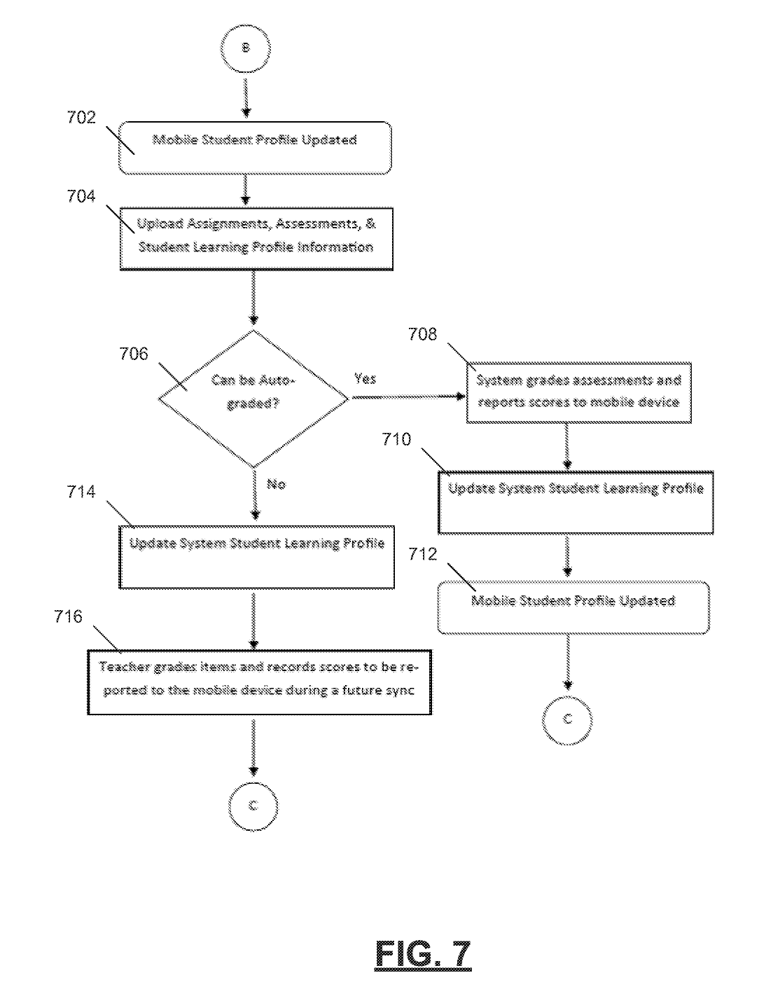

FIG. 7 is a flow diagram illustrating example processing performed when a student has finished his or her assignments when the device is online. At 702, the mobile student profile is updated based upon the completed assignments. The assignments, assessments, and student learning profile information is uploaded to the remote server at 704. The system inquires at 706 whether the uploaded content can be auto-graded. If it can be auto-graded, then the system automatically grades the assessments and reports the scores to the mobile device at 708. Both the system student learning profile and the mobile student profile are updated at 710, 712, respectively, before processing continues as indicated by continuation marker “C.” If the uploaded content cannot be auto-graded at 706, the system student learning profile is updated at 714. The teacher grades the items and records scores at 716 which are to be reported to the mobile device during a future synchronization operation. Processing then resumes as indicated by continuation marker “C.”

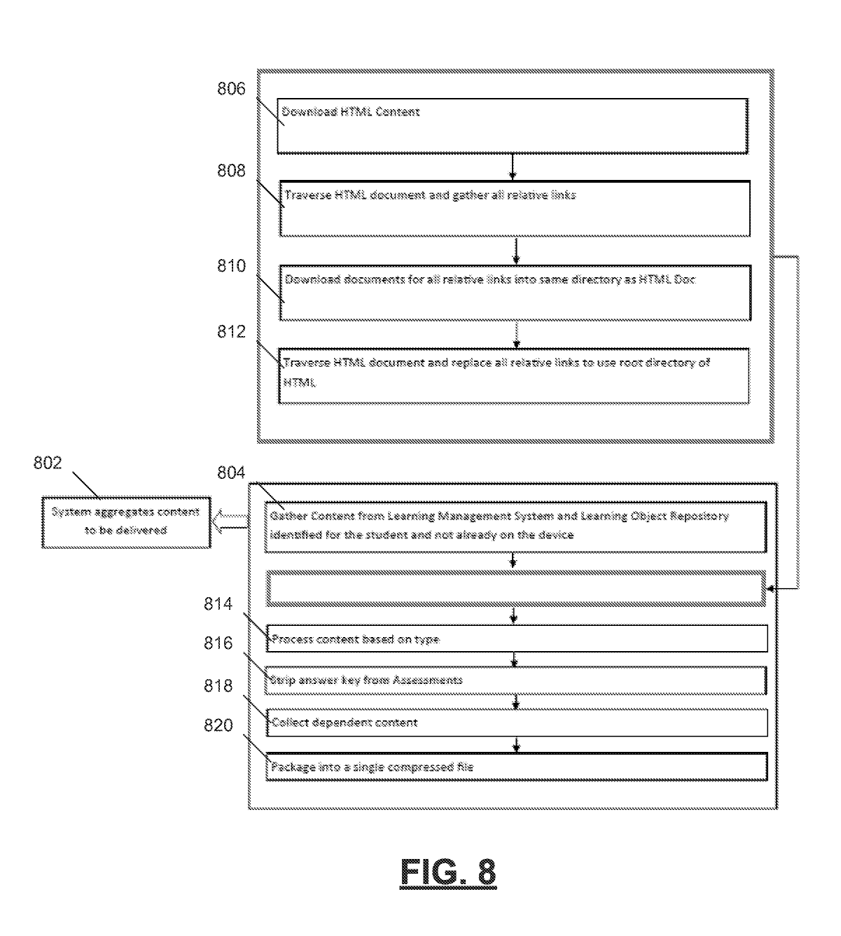

FIG. 8 is a flow diagram that describes additional example synchronization operations involving educational multimedia objects. In the scenario of FIG. 8, the system aggregates content to be delivered to a student mobile device at 802. In one embodiment, content is gathered from the learning management system and learning object repository that has been identified for a specific student and not already on the device at 804.

After the correct content has been gathered, the HTML content is downloaded at 806 from multiple sources varying from creative commons content to for-fee content as regulated by Digital Rights Management (DRM) restrictions, for ultimate downloading to a mobile device. Content may be gathered from multiple different sources in order to comply with educational standards (e.g., common core educational standards, Ohio educational standards, etc.). For example, a particular lesson may involve multiple educational multimedia objects in order to comply with an educational standard. The synchronization operations, in this example, examines these interdependencies among objects relative to criteria, such as educational standards, so that the proper content can be downloaded to meet any applicable educational standards as well as ensuring that all of the proper content has been downloaded and is accessible to the student even if the mobile device is off-line.

For example, at 808, the synchronization software traverses the HTML document that has been downloaded and gathers all relative hyperlinks. The documents for all relative links are downloaded at 810 into the same directory as the HTML document. The HTML document is traversed at 812, and all relative links are replaced so that there is a reference to use the root directory of the HTML document.

The content is processed based upon type at 814 because an HTML document is processed differently than a PDF document, etc. The answer key is then stripped from the assessments at 816. Content that is dependent upon complementary information is collected at 818. The complementary information can include what teachers are selecting, such as specific content for a particular student to help a student. A teacher may do this in order to associate an educational standard to the particular student and find specific content aligned to the standard for viewing by the student. This aggregated content (e.g. the downloaded HTML content which has been processed, the collective dependent content, etc.) is packaged into a single compressed file at 820 for delivery to a mobile device.

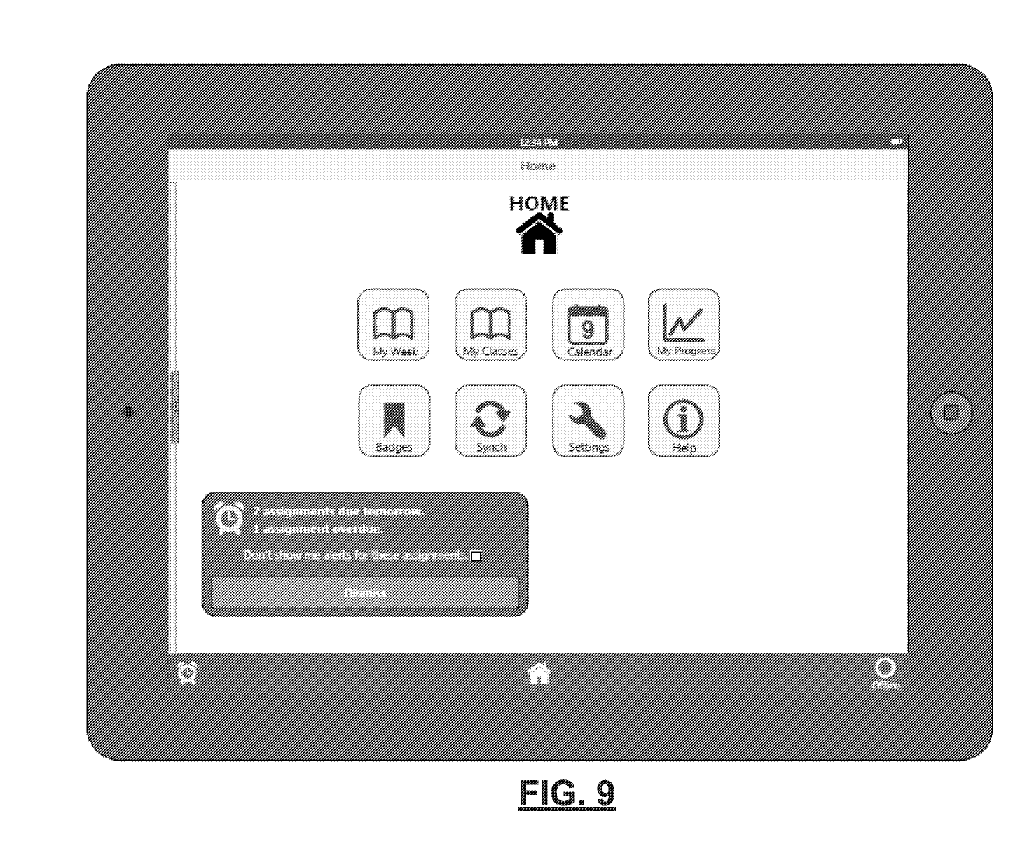

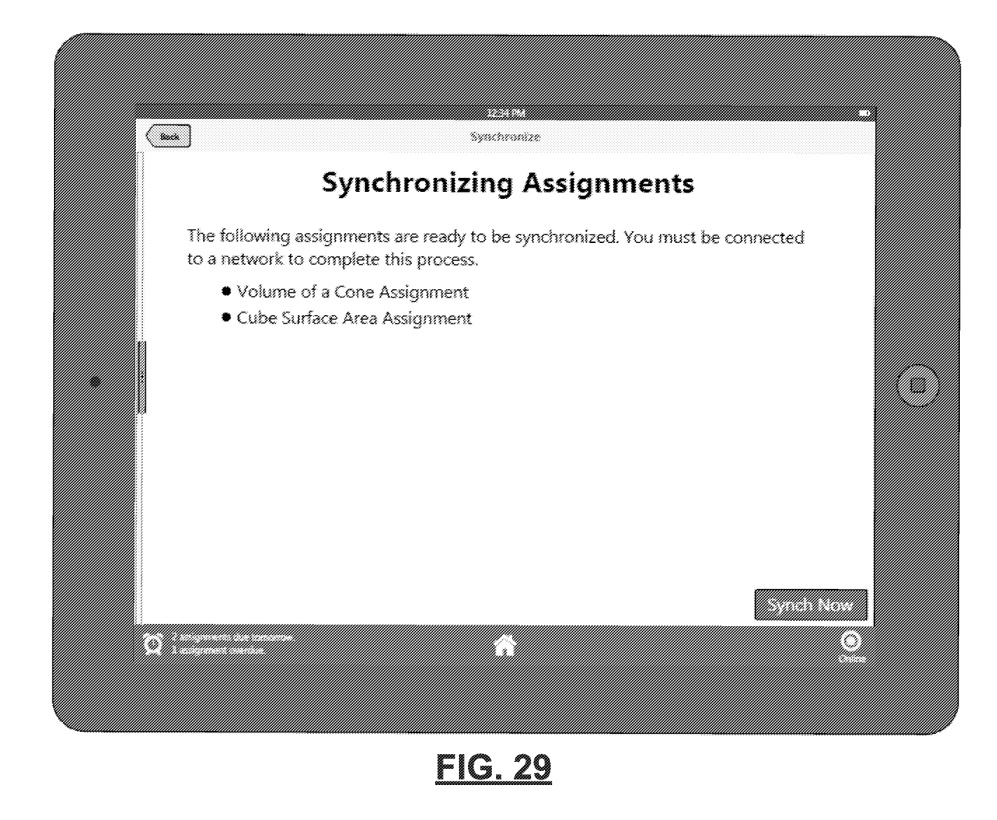

FIGS. 9-37 depict example graphical user interfaces for providing content via a learning management system. FIG. 9 depicts a home screen from which a student can select an activity to perform on a mobile device. The home screen includes a My Week link to an assignment and other activity schedule, a My Classes link to a class status schedule, a Calendar link for viewing upcoming events and activities, a My Progress link for viewing assignment and assessment completion and score progress, a Badges Link for viewing achievement status, a Synch link for forcing a synchronization with a learning management system when the mobile device has network connectivity, a Settings link, and a Help link. The home screen further provides alerts of assignments, assessments, or other activities that are coming due, overdue, or otherwise ready for student attention.

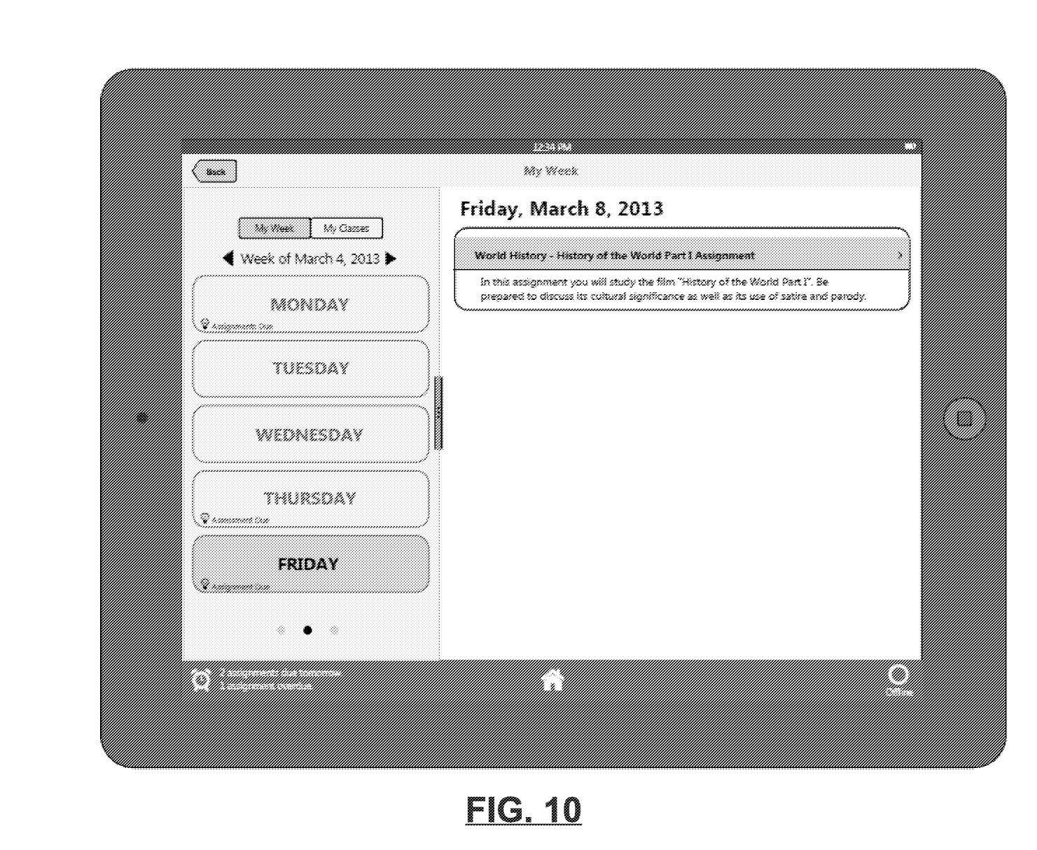

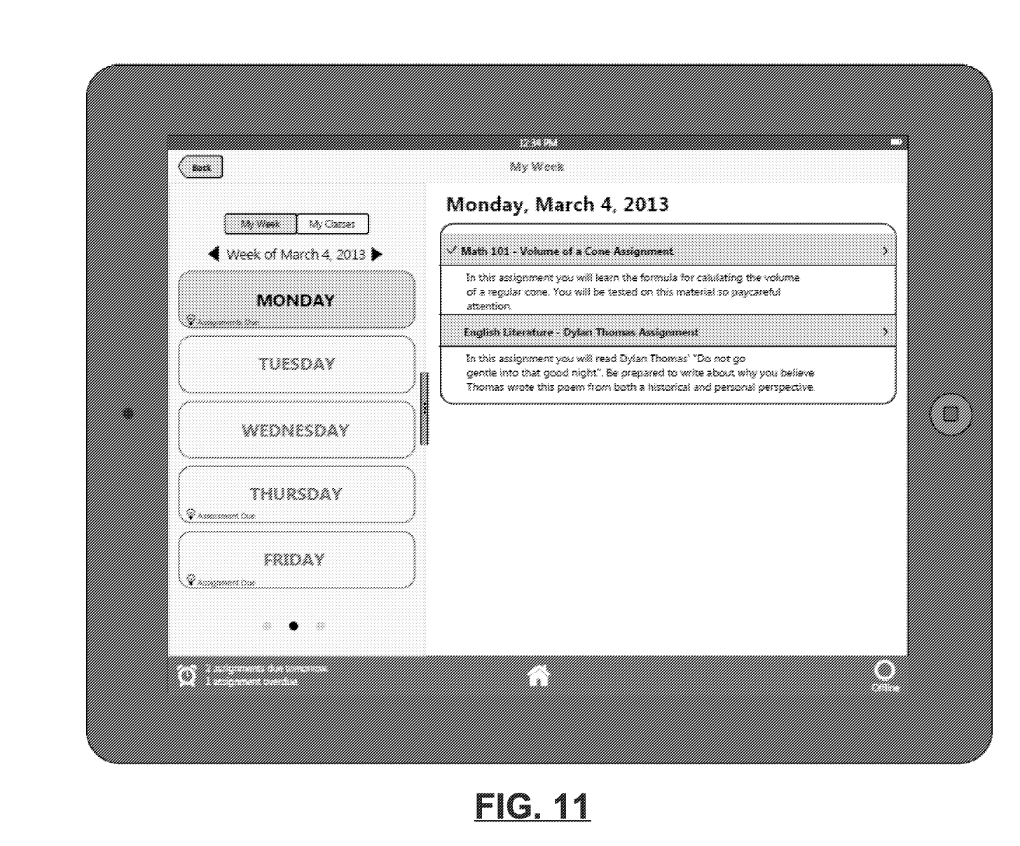

FIG. 10 depicts an example My Week schedule browsing interface. A list of days of the week appears in a left pane with indicators on days assignments are due. By selecting a day, assignments, assessments, and other activities associated with that day appear in the right pane. By selecting a right pane entity, the student may interact with that activity using the mobile device, such as to learn more details of the activity, to participate in a learning exercise, or to take an assessment. In the example of FIG. 10, the graphical user interface displays one assignment due on Friday that has not yet been completed by the student. FIG. 11 depicts the graphical user interface after a selection of Monday, indicated as having multiple assignments due in the left pane, where the right plane describes the assignments and indicates that the student has completed one of the assignments via a display of a check mark.

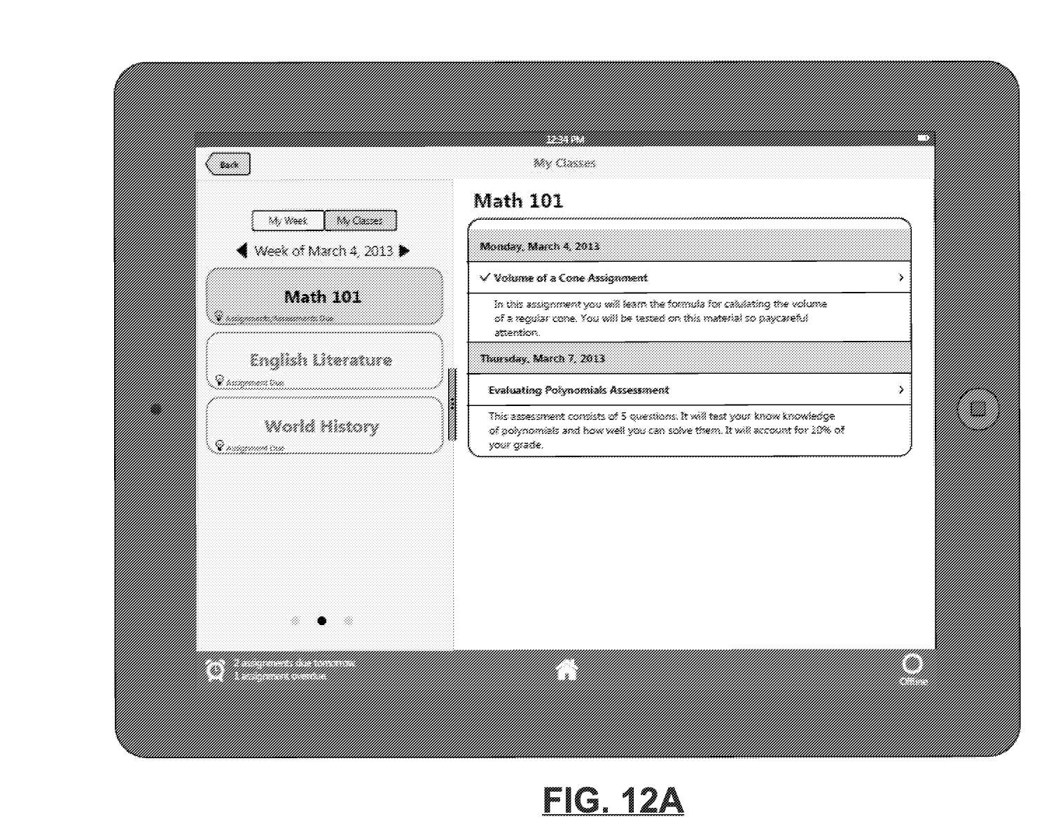

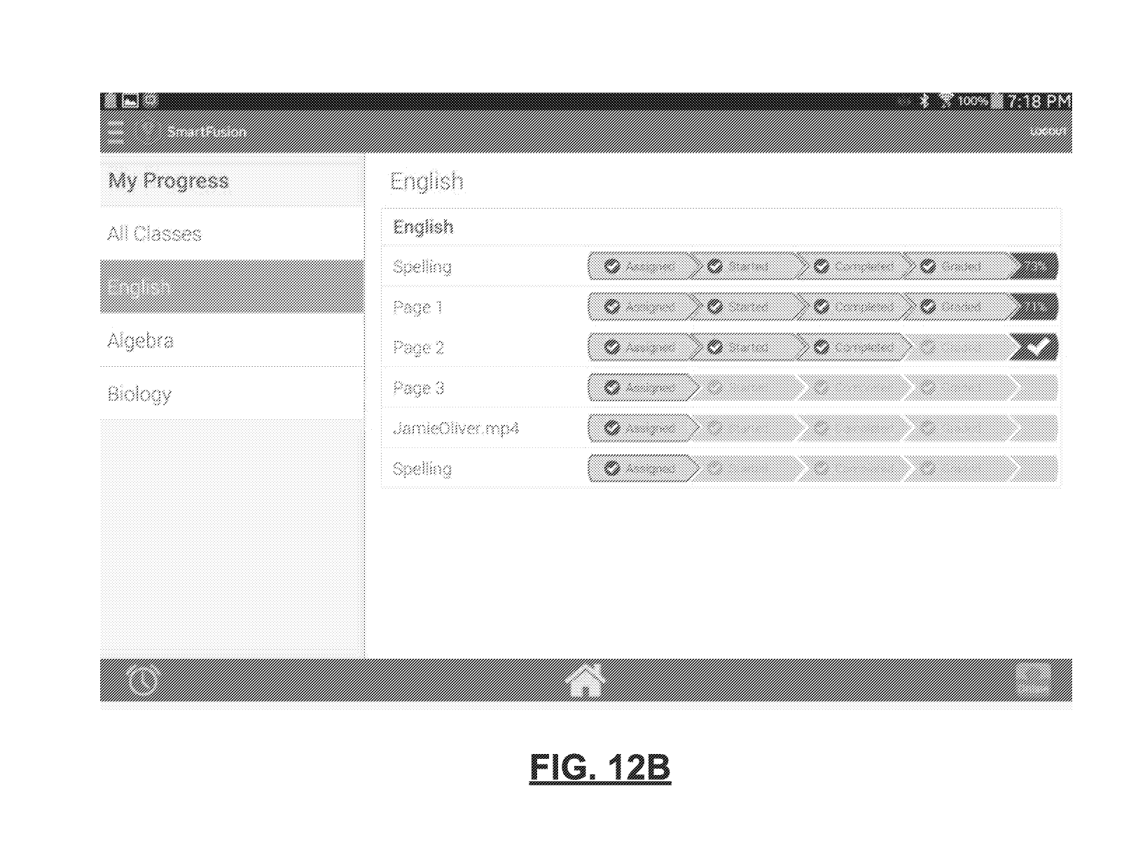

FIG. 12A depicts a My Classes view, such as via the left pane indicator or selection of My Classes from the home screen. In a left plane, classes with which a student is associated are displayed along with indicators of whether assignments or assessments are due for those classes. Upon selection of a class, the graphical user interface is configured to display assignments, assessments, or other activities assigned for that class, organized by date, along with an indicator as to completion. A navigation bar at the bottom of the user interface can include a link to other pages, such as the Home page, reminders of upcoming assignments, assessments, or other activities coming due, and an indicator as to whether the mobile device currently has network connectivity.

FIG. 12B depicts another example display for showing progress in a class, where each of a plurality of assignments for an English class are displayed along with an indication as to the status of those assignments, including statuses for Assigned Assignments, Started Assignments, Completed Assignments, Graded Assignments, and scores for graded assignments.

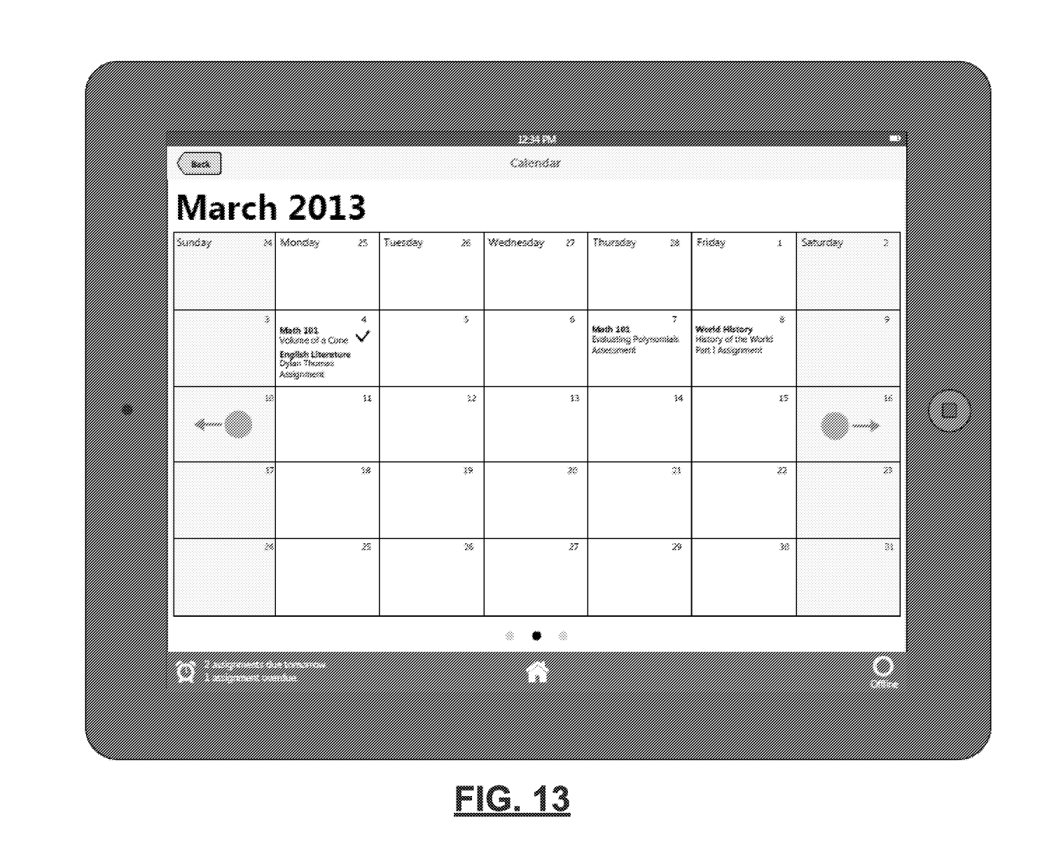

FIG. 13 depicts a calendar view that depicts assignments, assessments, or other activities due according to date. Indicators are displayed to indicate status, including a check mark for completion. The graphical user interface is configured to transition through display of different months via a swipe or other user input.

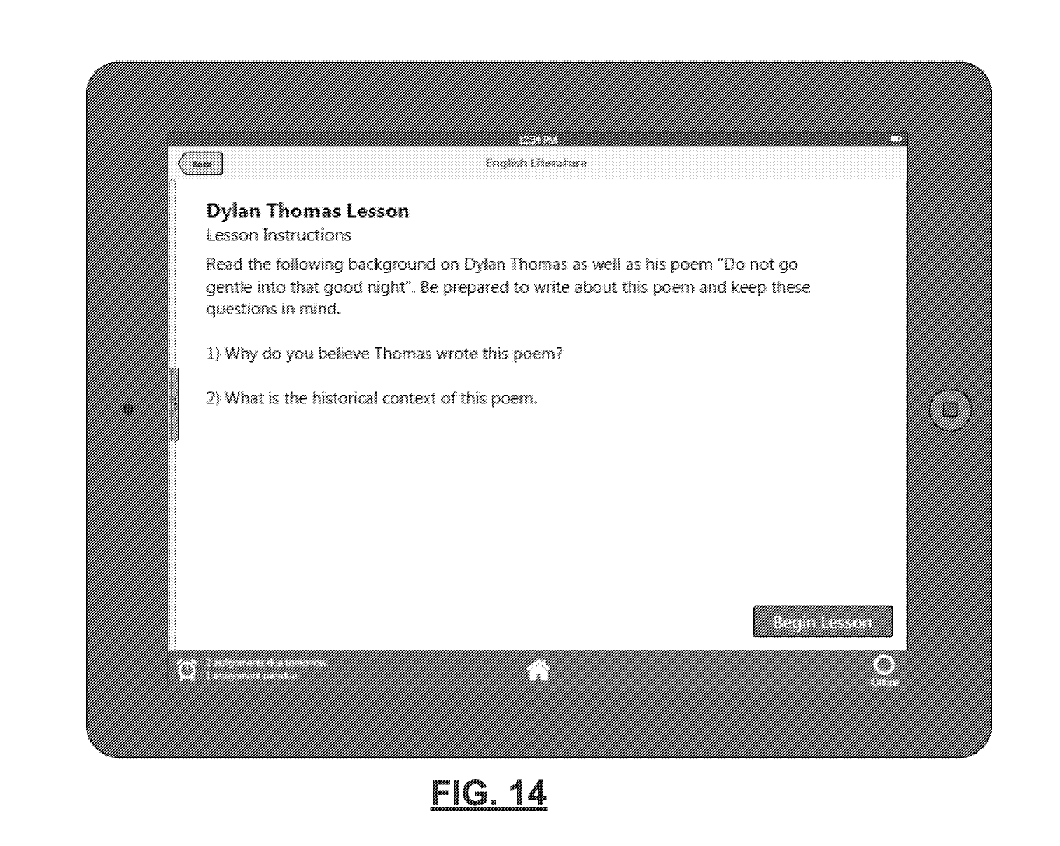

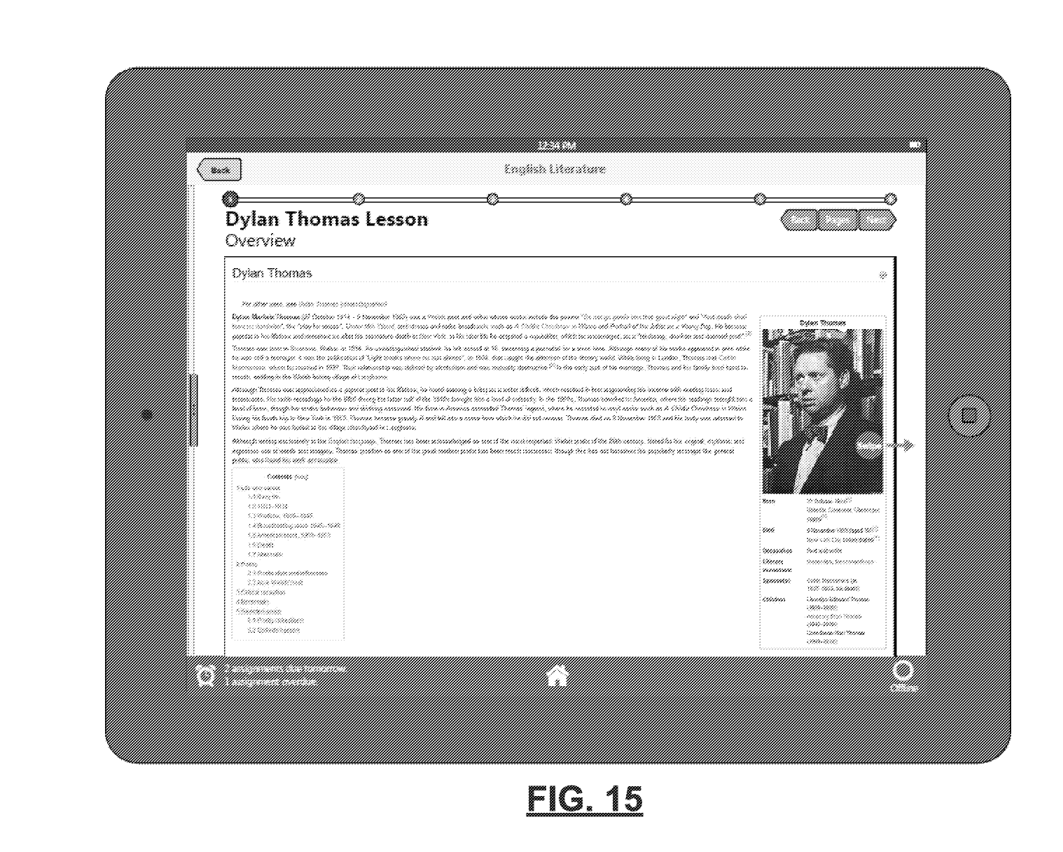

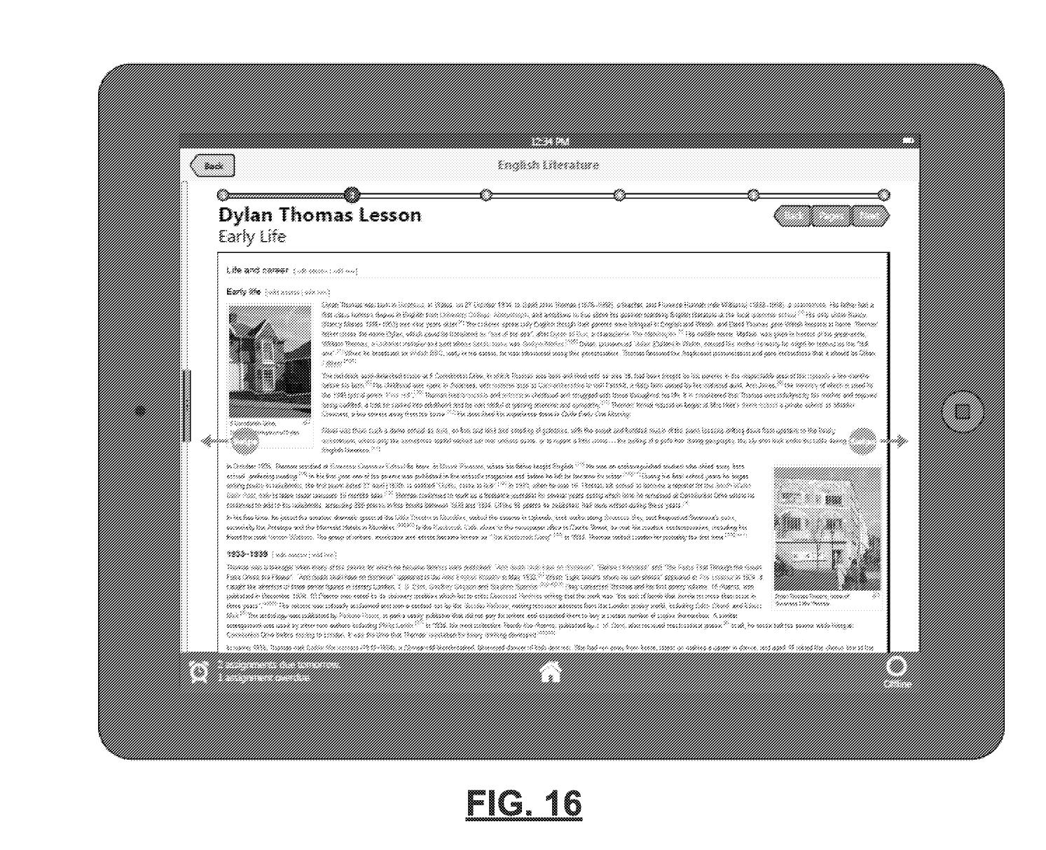

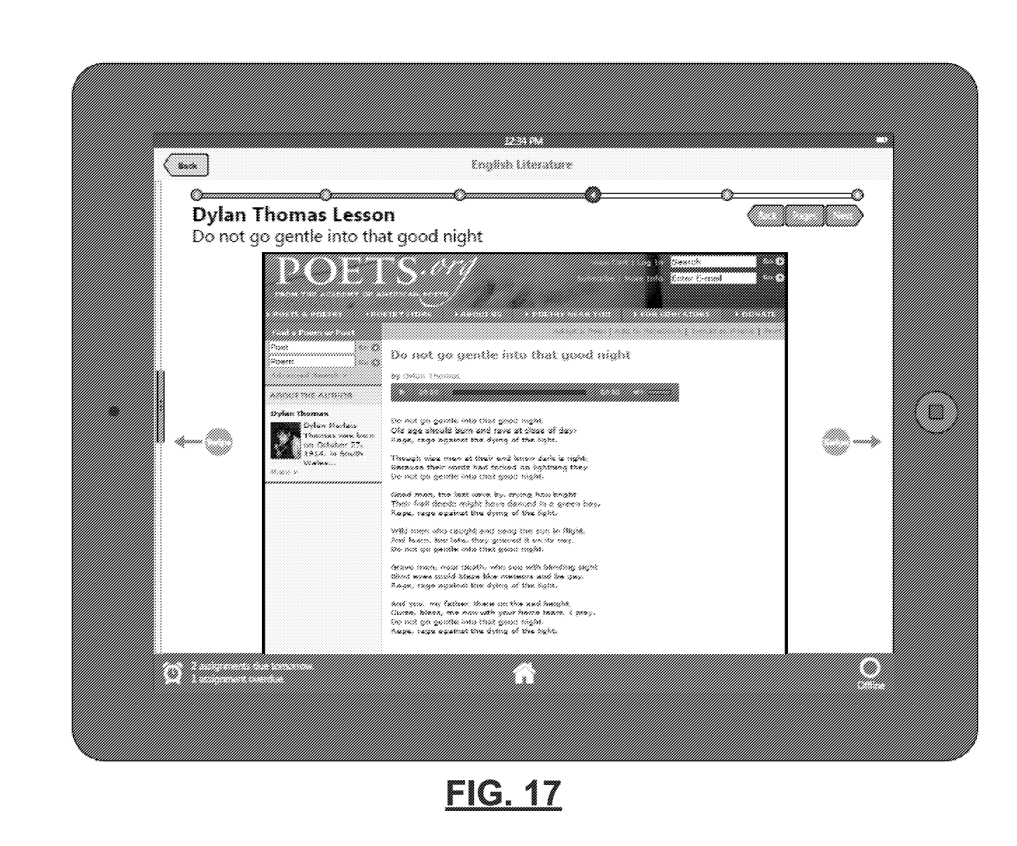

FIGS. 14-20 depict an example learning activity and corresponding assignment for an English Literature class. The activity and assignment can be accessed through a variety of mechanisms, such as via a My Week link, a My Classes link, a Calendar link, or a reminder link. FIG. 14 displays an introduction screen that previews content that will be displayed. FIG. 15 displays a first content page that is derived from a website. As indicated by the Offline status bar icon, the mobile device is operating in an offline mode. However, because the learning management system has previously captured the webpage, supporting content (e.g., the picture of Dylan Thomas), and other associated content (e.g., content of web pages linked to by the displayed page to a certain number of link-levels (e.g., grandchild links)), the mobile device is able to display the desired content without network connectivity. The graphical user interface includes a lesson status bar at the top of the screen along with navigation controls. Stages of the lesson can be traversed via the lesson status bar, the navigation controls, or via swipes or other interactions received by the mobile device. FIG. 16 displays a second page of the lesson, a display of a second web page. The lesson is designed by an instructor, who selects the desired web pages or other content to be displayed as well as an ordering of that content. FIG. 17 displays another web page from a different domain that includes the text of a Dylan Thomas poem.

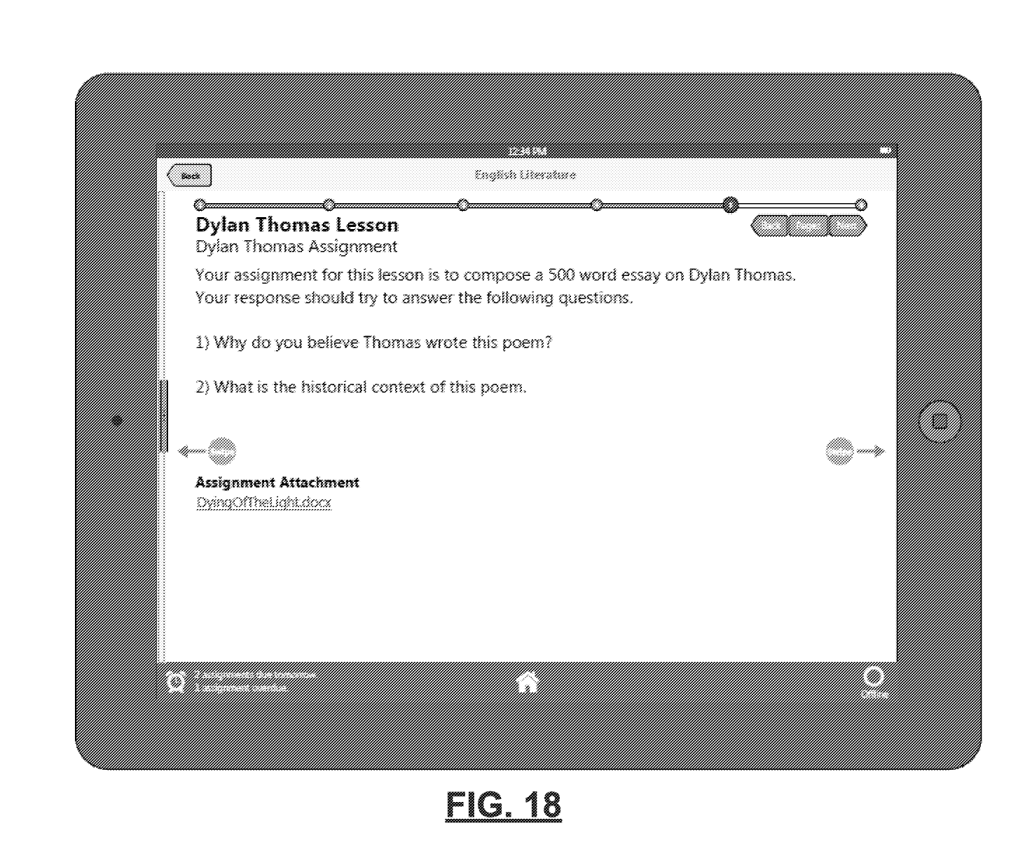

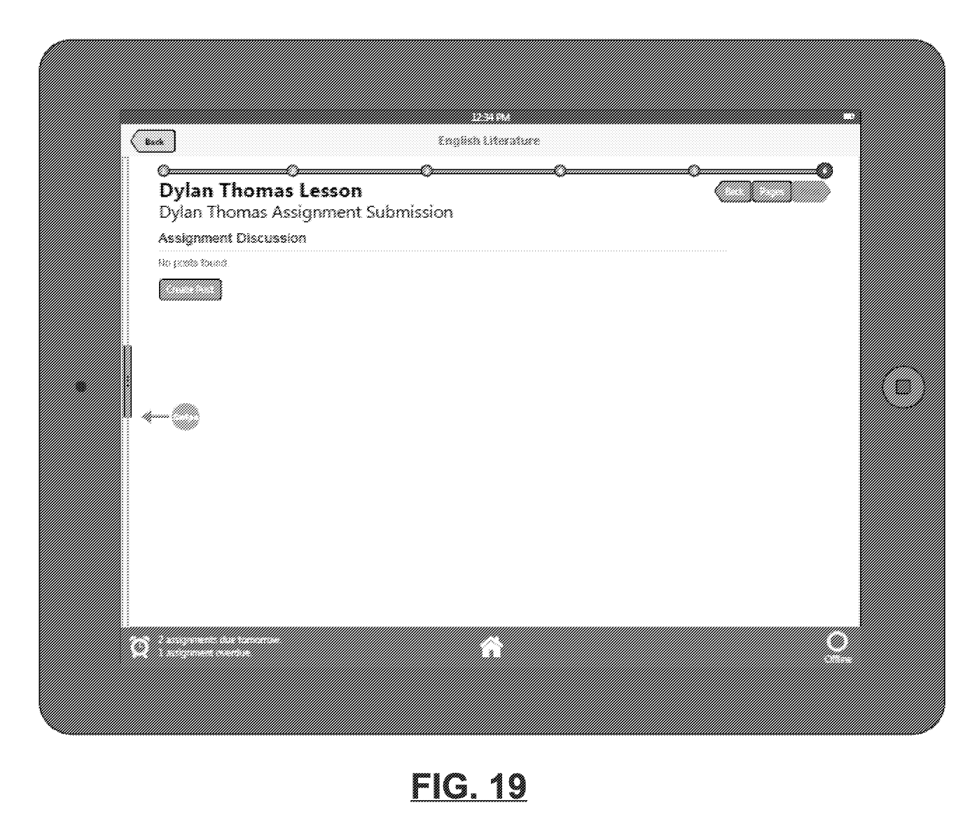

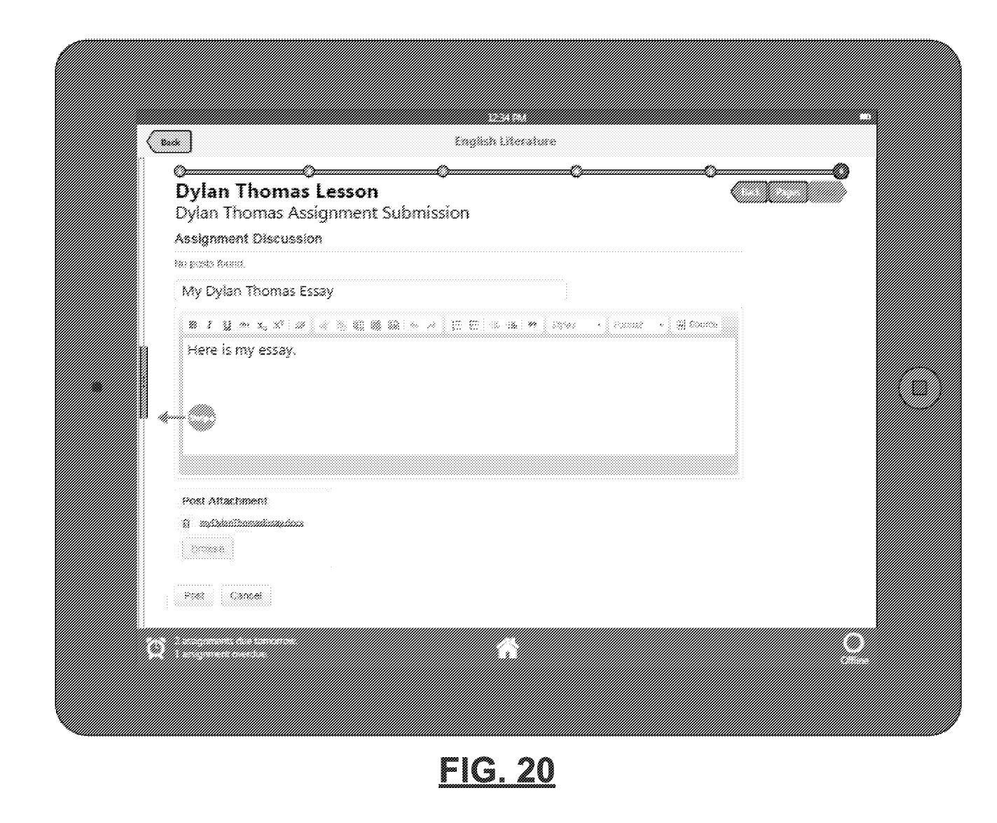

FIG. 18 depicts a graphical user interface showing an assignment associated with the aforementioned learning activity. The assignment instructs the student to draft an essay based on the learning activity. The assignment includes an attachment, which may be a form or shell into which the student is to enter the essay for subsequent upload. FIG. 19 displays a user interface for starting an assignment uploading following completion of the essay. FIG. 20 depicts a user interface for attaching an assignment attachment and including text to describe the upload. In some embodiments, the assignment work product can be directly entered into the user interface without the need for attachment upload.

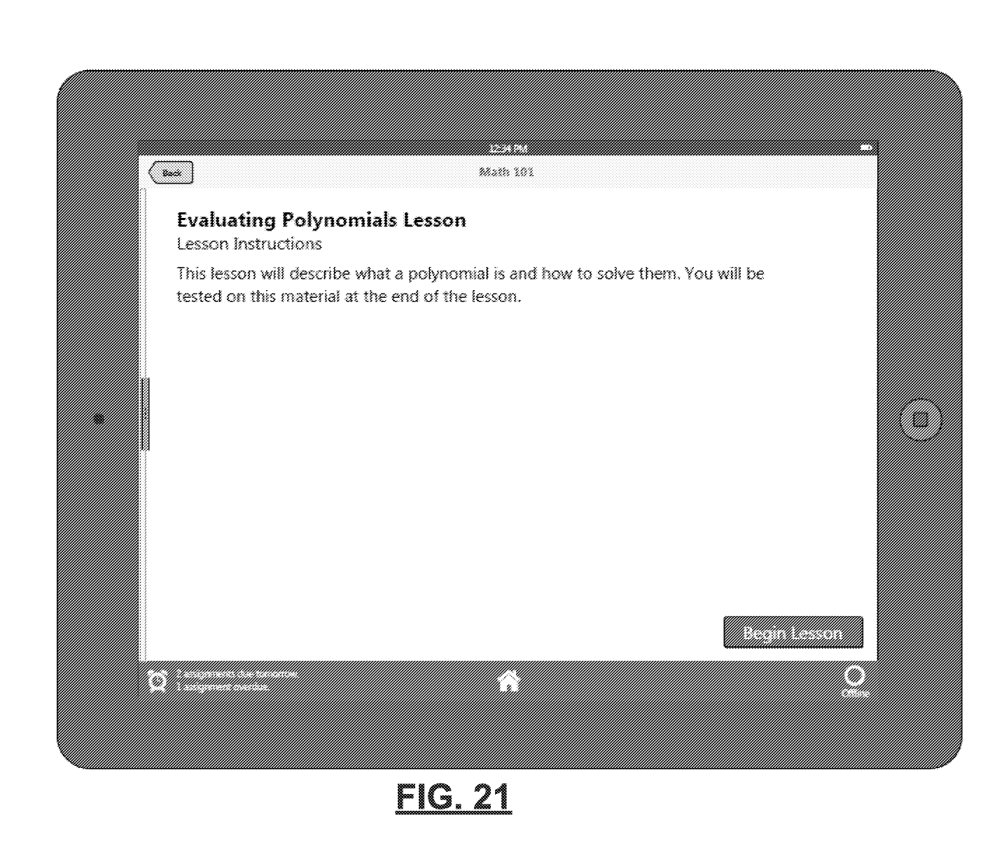

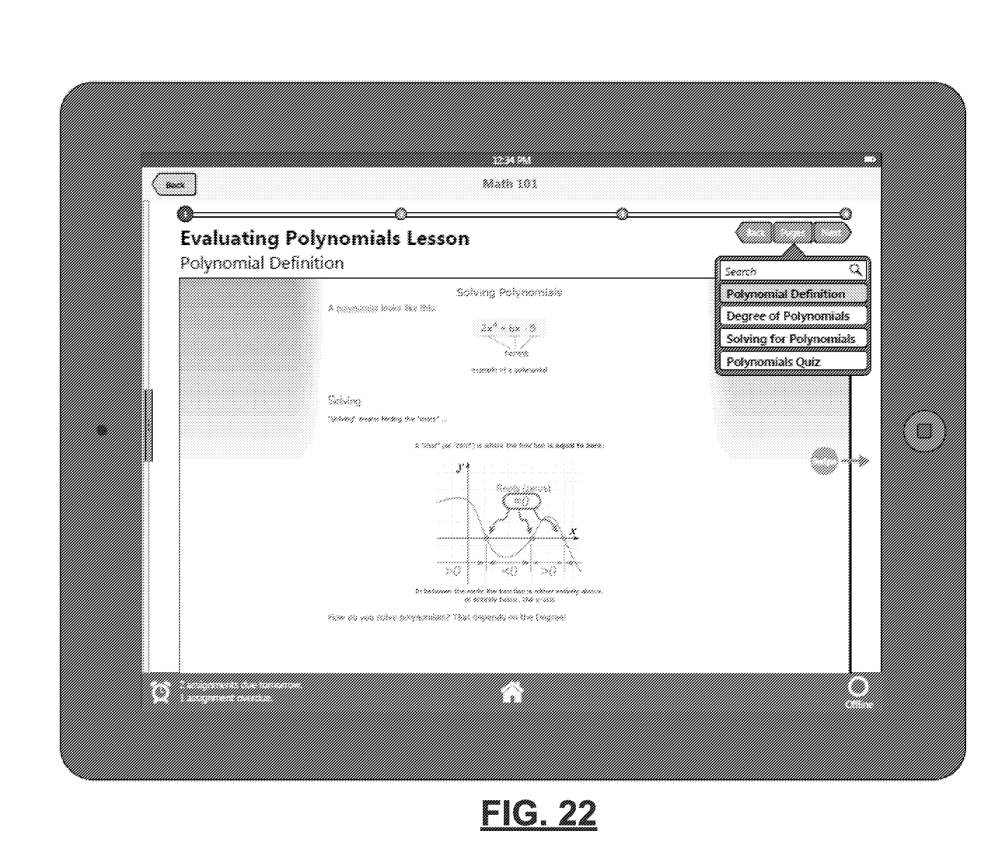

FIGS. 21-28 depict user interfaces for a second learning activity and a corresponding assessment. FIG. 21 depicts an introduction page for a lesson on evaluating polynomials. FIG. 22 depicts a first page of the lesson. The first page was designed by an instructor who entered text, selection of graphics, and an ordering of such, such as via a content design user interface. The graphical user interface on the mobile device enables viewing of the content page and navigation to other pages of the lesson, such as via a drop down table of content for the lesson.

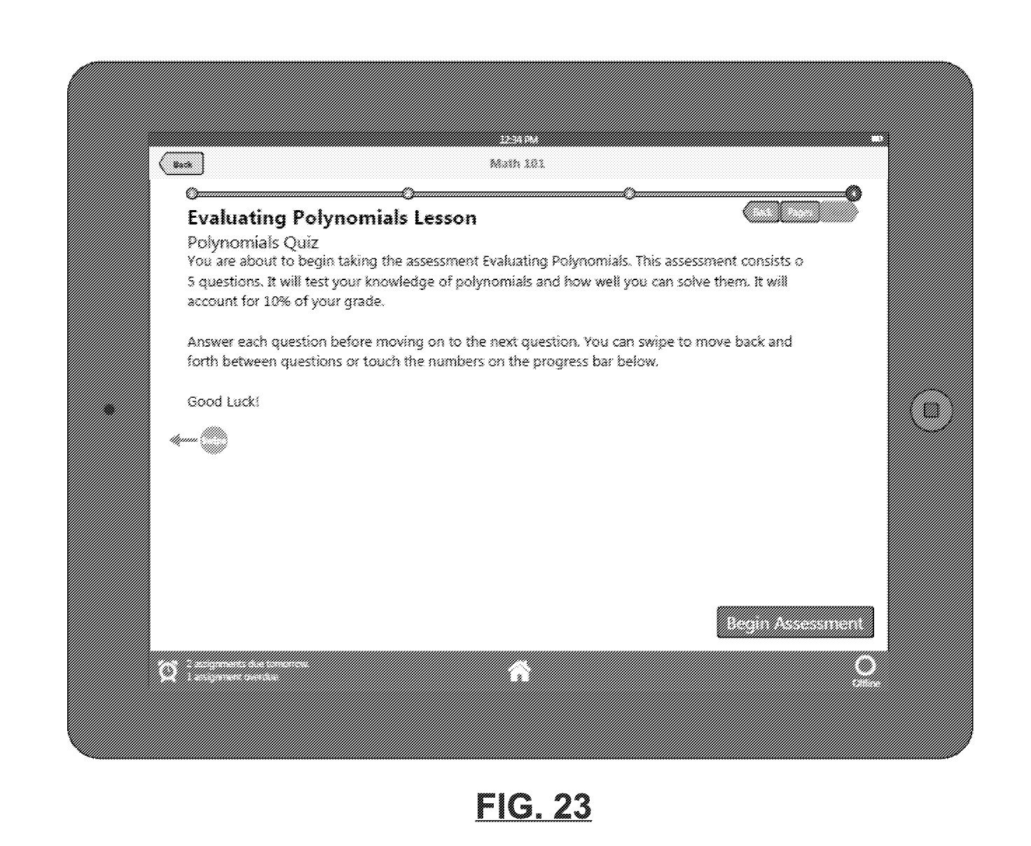

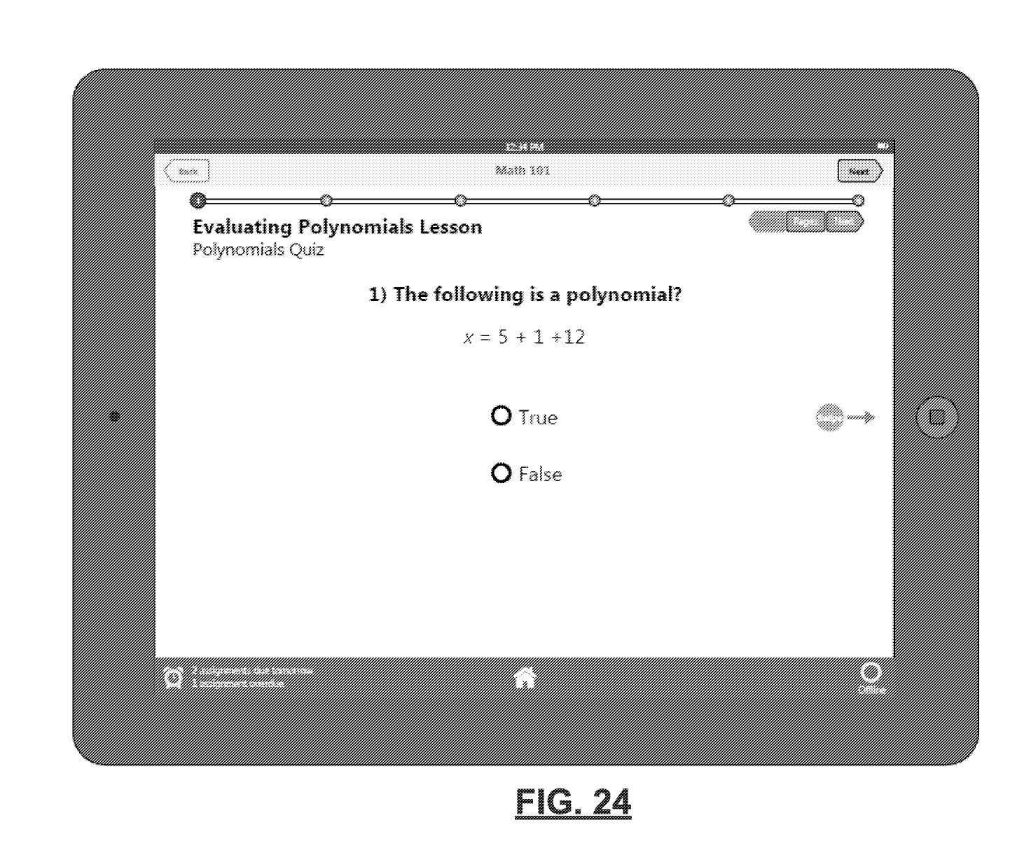

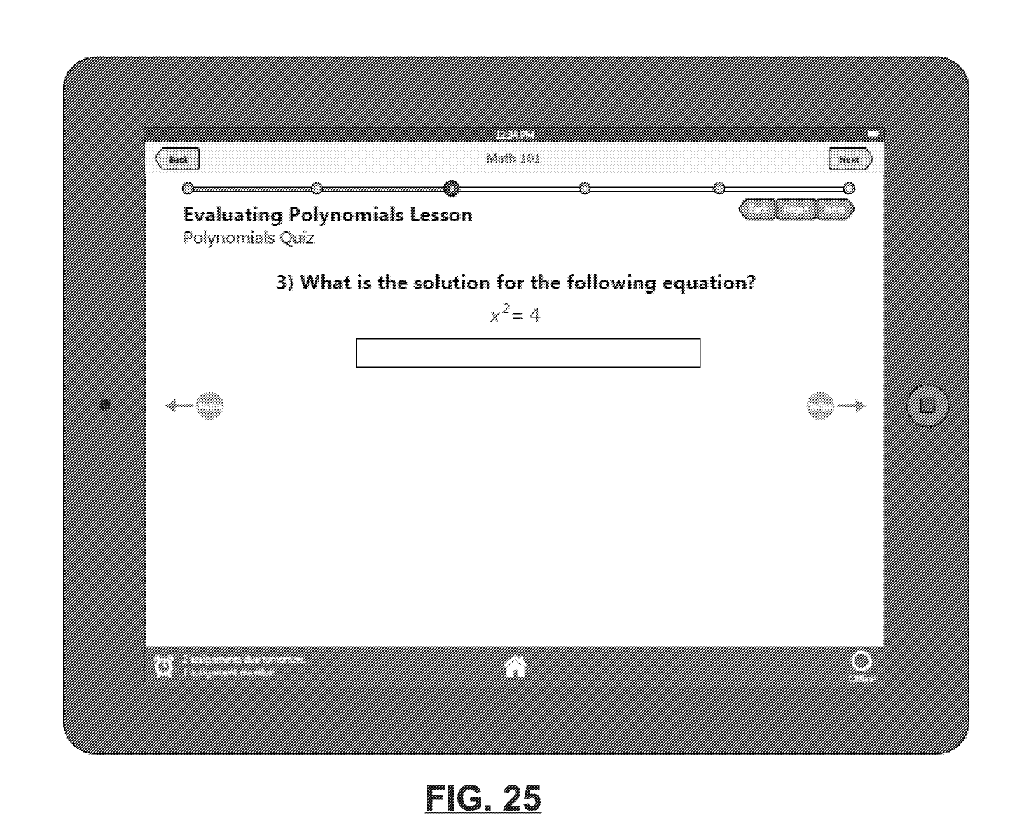

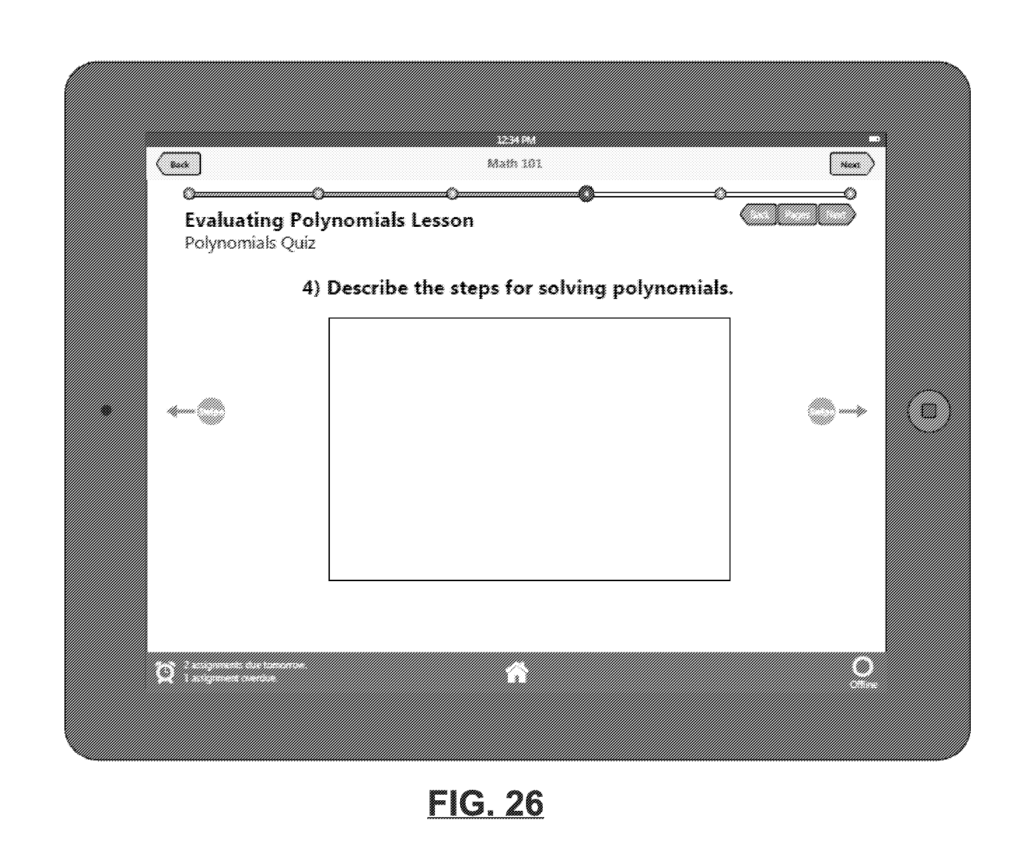

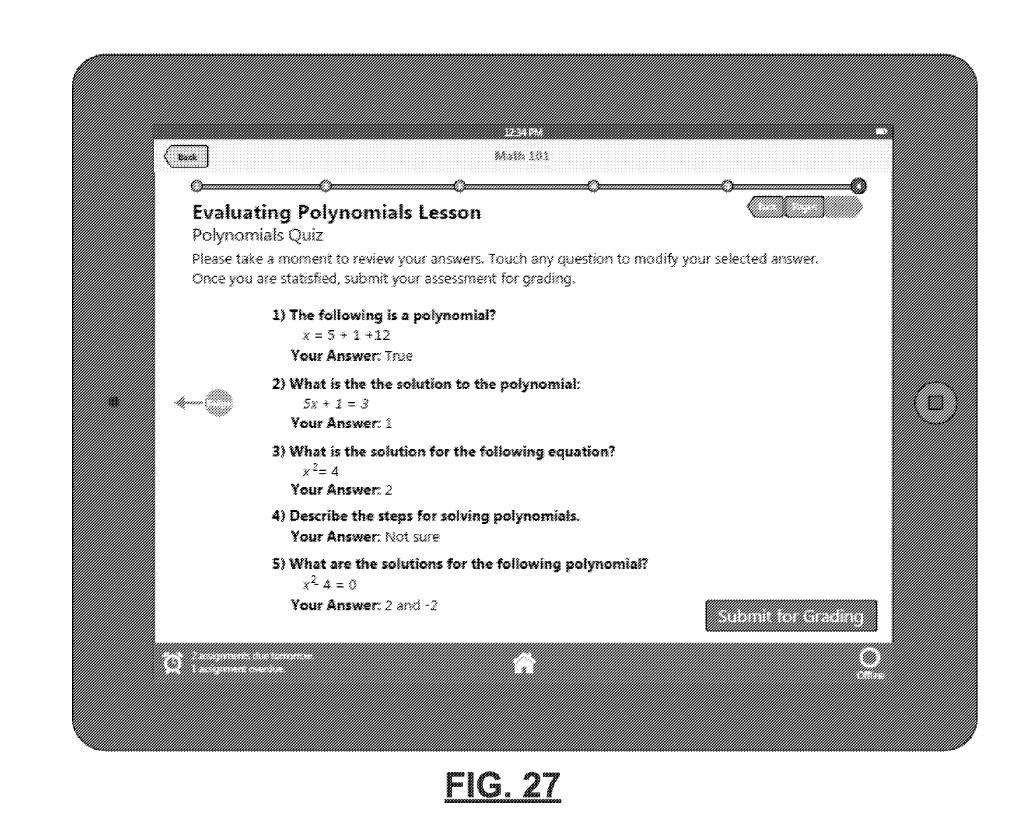

Following traversal of the learning activity portions of the lesson, the graphical user interface is configured to provide a quiz. FIG. 23 depicts an introduction page describing the upcoming quiz. FIG. 24 depicts a true-false question that is answerable via a radio button selection. FIG. 25 depicts a question answerable via a free text field of a particular length. FIG. 26 depicts a question answerable via a free text field of a longer length. FIG. 27 depicts a quiz answer review display, where the graphical user interface displays entered answers for confirmation prior to submission for grading.

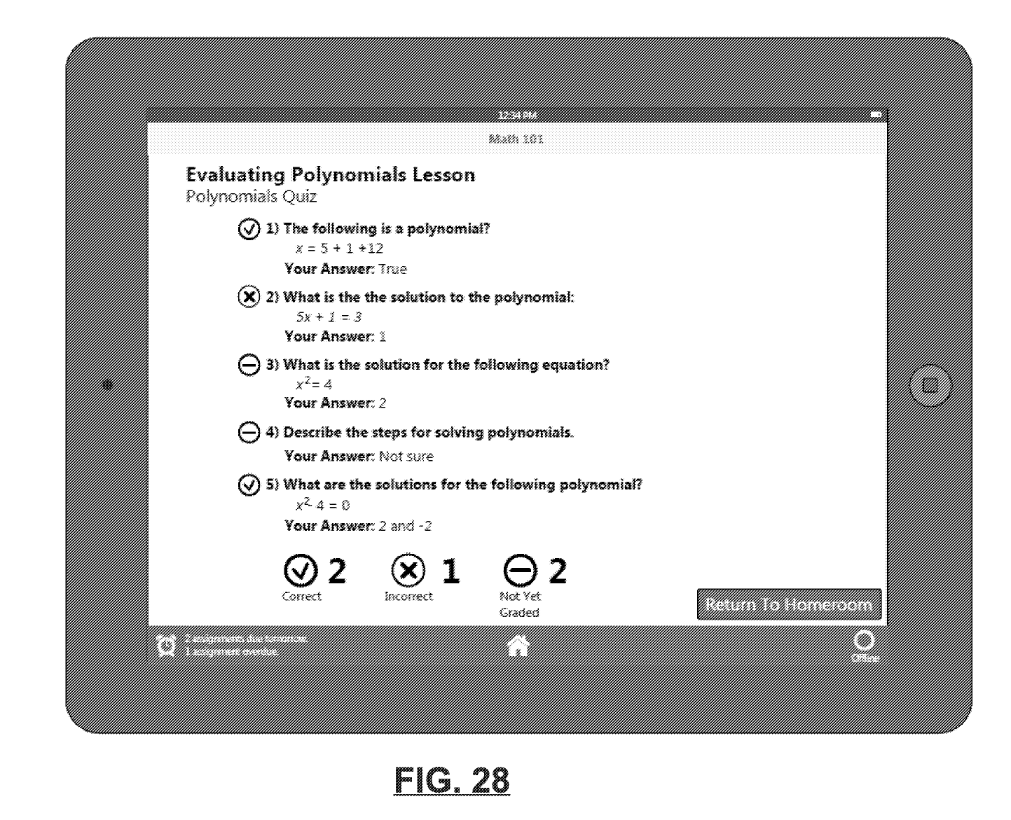

In one embodiment, some or all of the answers submitted are graded instantaneously. The answers may be graded automatically by the mobile device, or the answers may be transmitted to the learning management system for grading when the mobile device is operating in an online mode. In the example of FIG. 28, a portion of the quiz answers are graded without human involvement, and those scores are provided to the student. Certain answers, such as certain free text answers, require teacher or other human grading. Those answers are transmitted to the learning management system, where human scores are transmitted to the mobile device for display following human scoring. Thus, while FIG. 28 depicts a partially graded quiz, traversing to the quiz at a later time may display full scoring results.

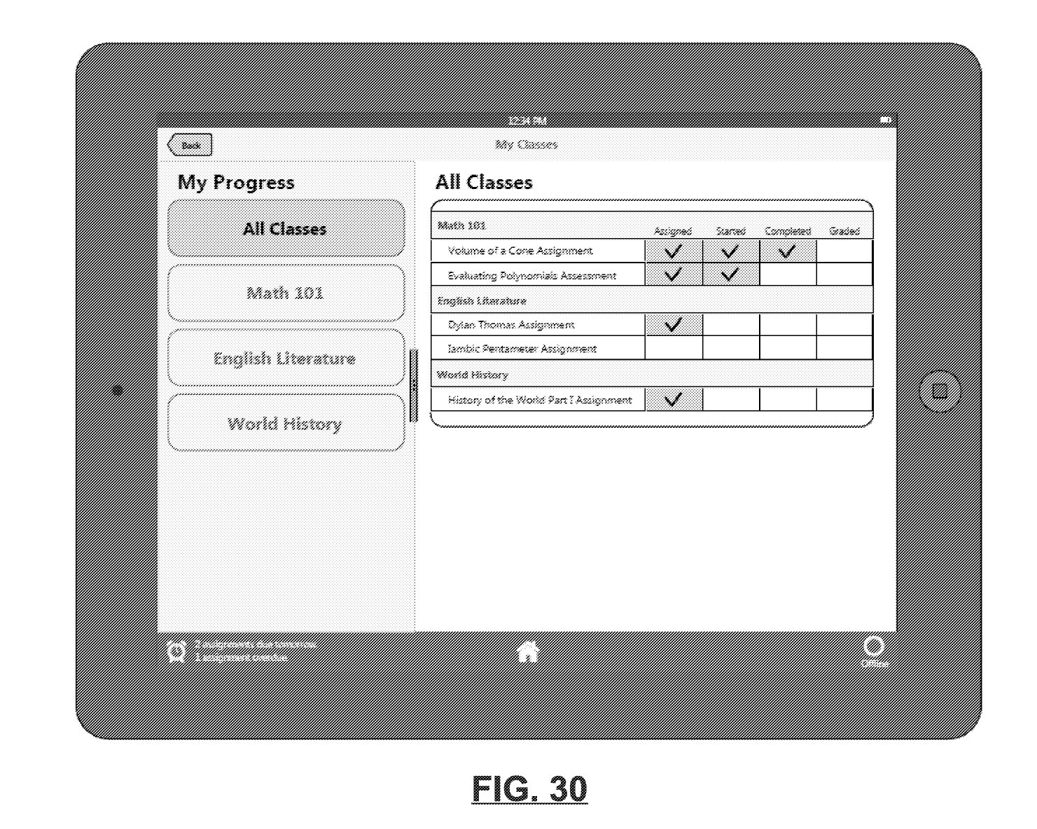

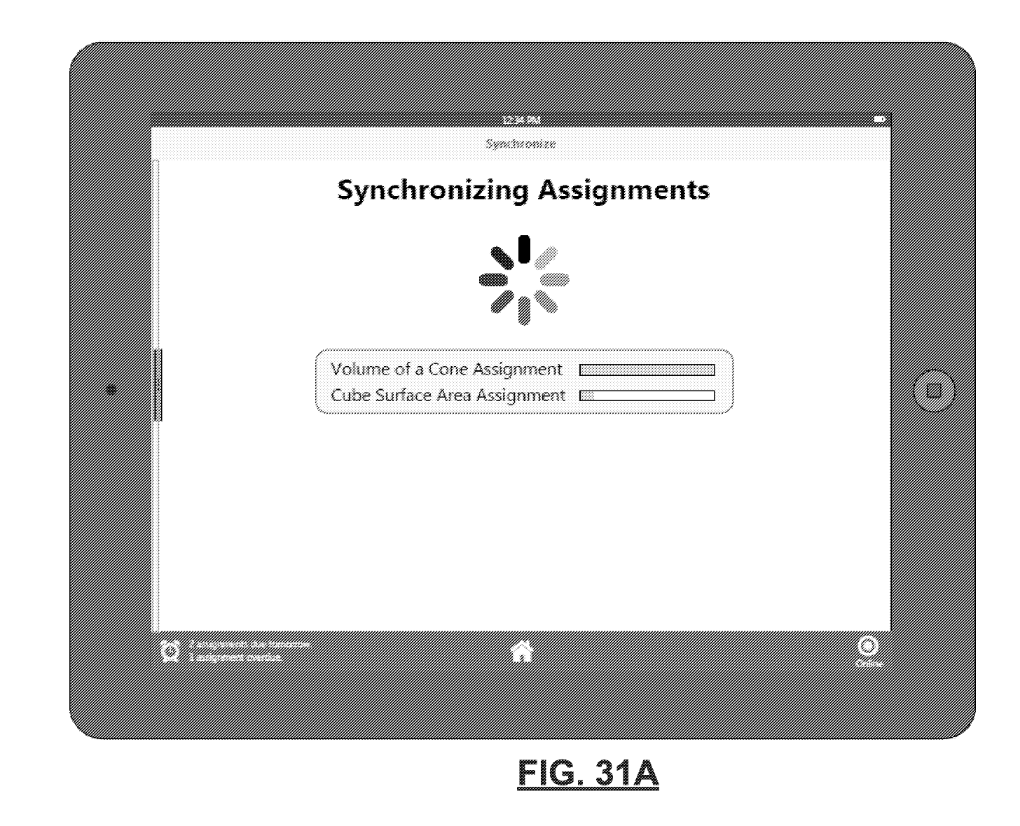

FIG. 30 depicts a My Progress page, where a graphical user interface depicts summary data related to all active assignments, activities, and assessments. The My Progress page enables ascertainment of whether an action item has been assigned, started, completed, and graded. Such a display enables fast discernment of uncompleted tasks.

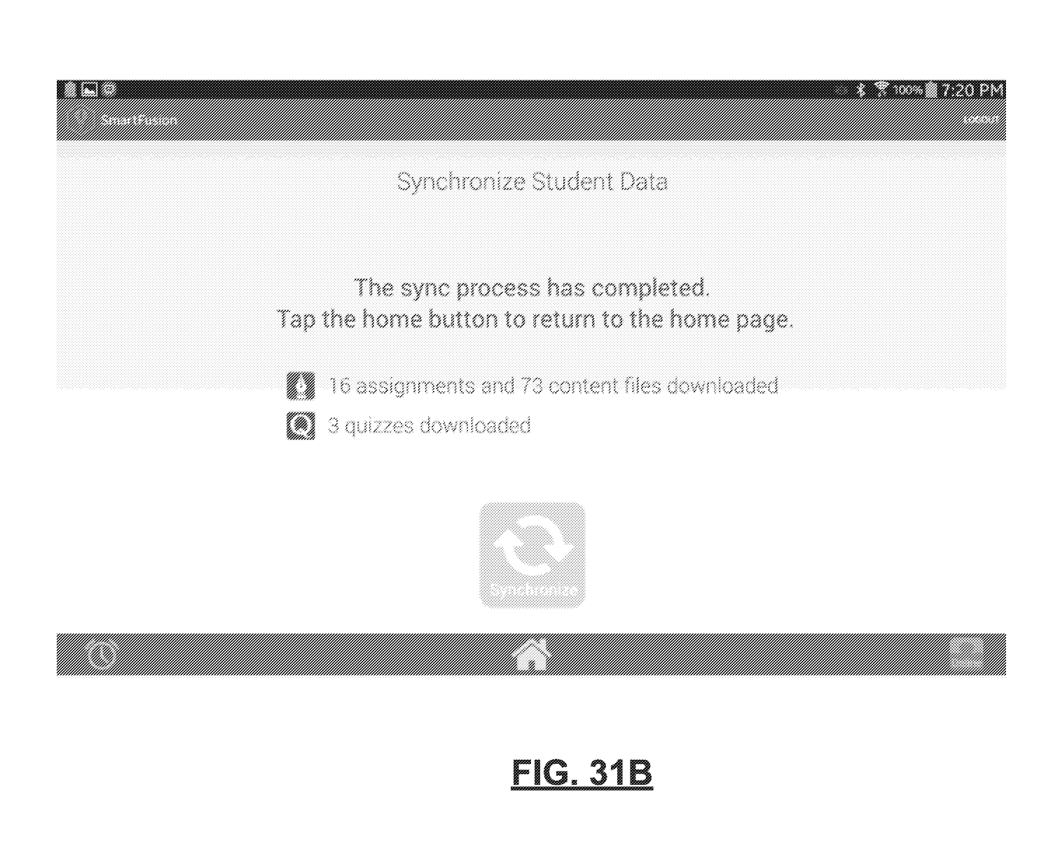

FIG. 31A depicts a synchronization progress page. Synchronization between the mobile device and the learning management system may occur periodically when the mobile device is operating in an online mode. For example, synchronization may occur at predetermined intervals or when assignments, activities, or assessments are completed. Synchronization can also be forced by selection of a Synchronization command, such as to force immediate downloading and uploading of content. FIG. 31B depicts a synchronization summary page that identifies the number of assignments content files, and quizzes that were downloaded.

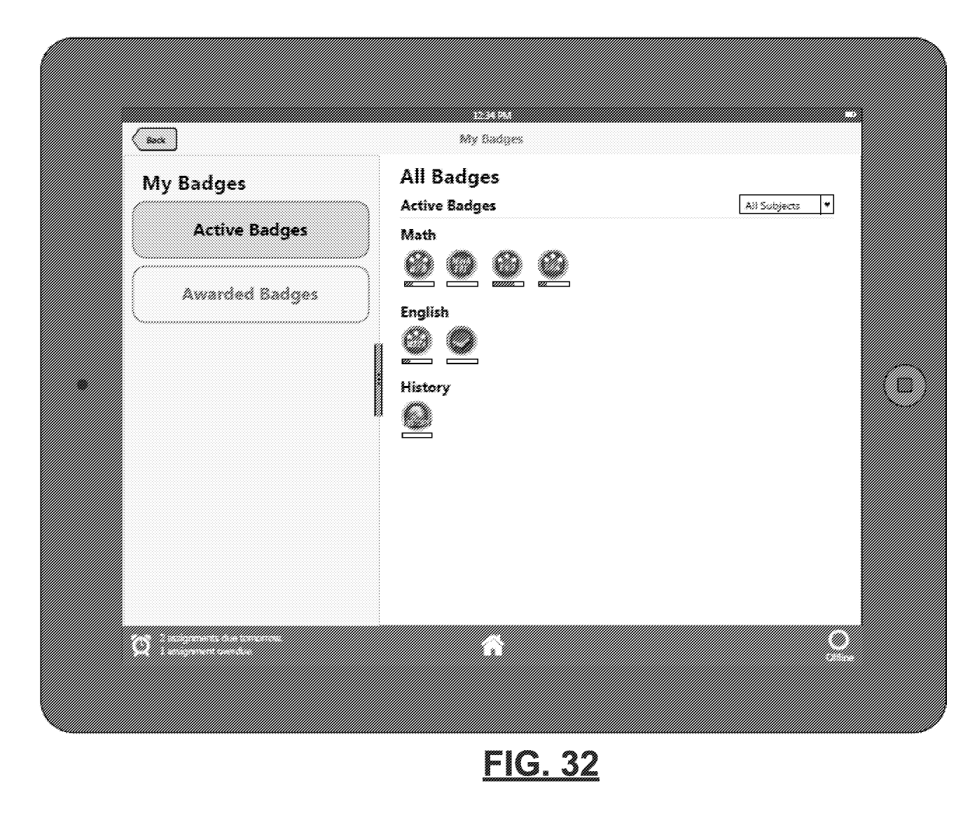

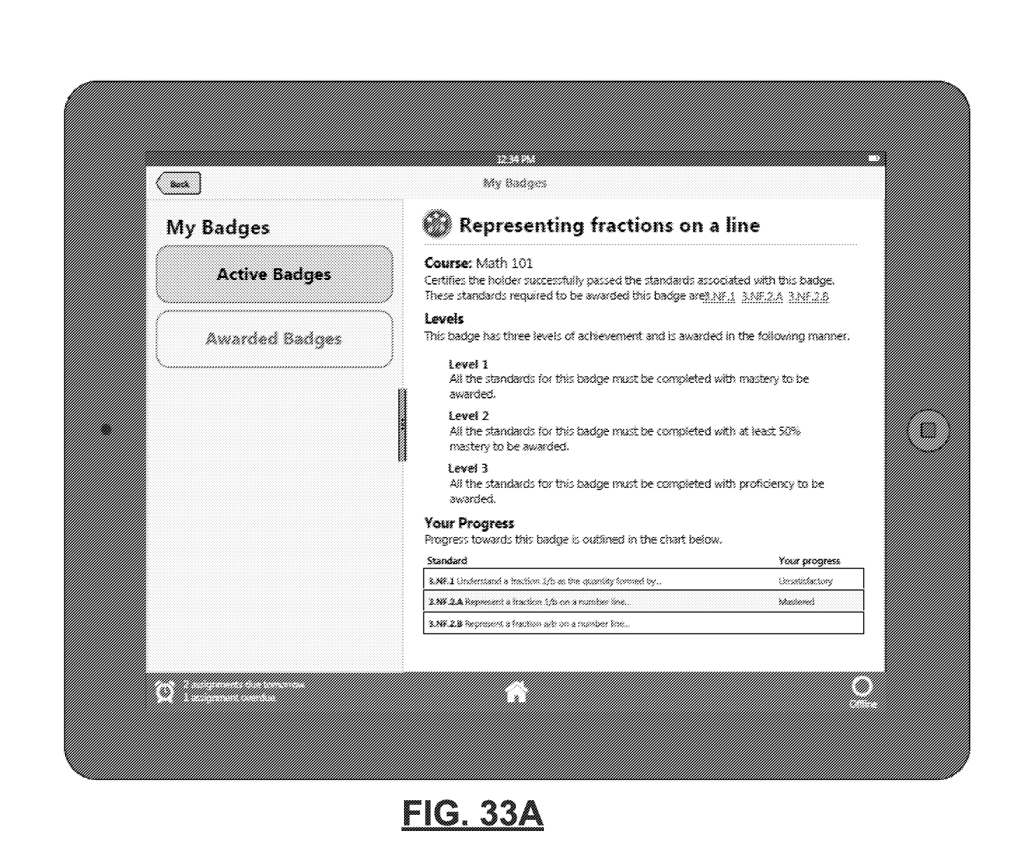

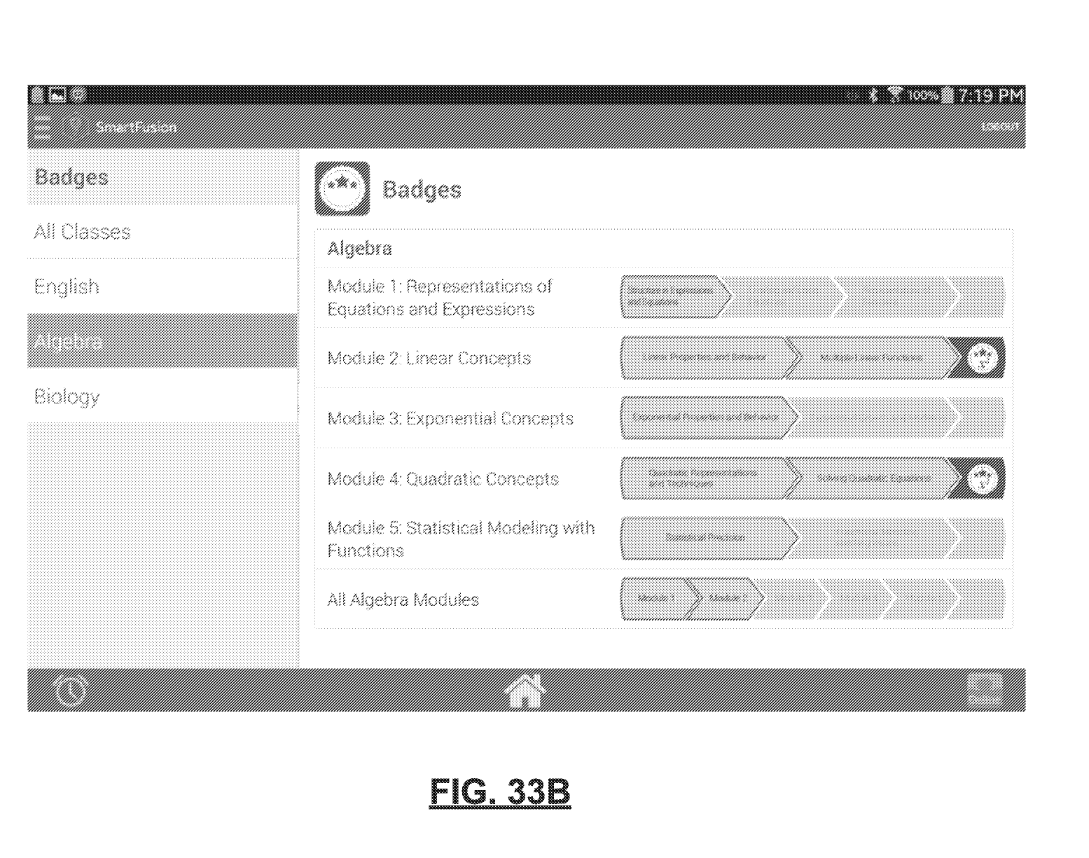

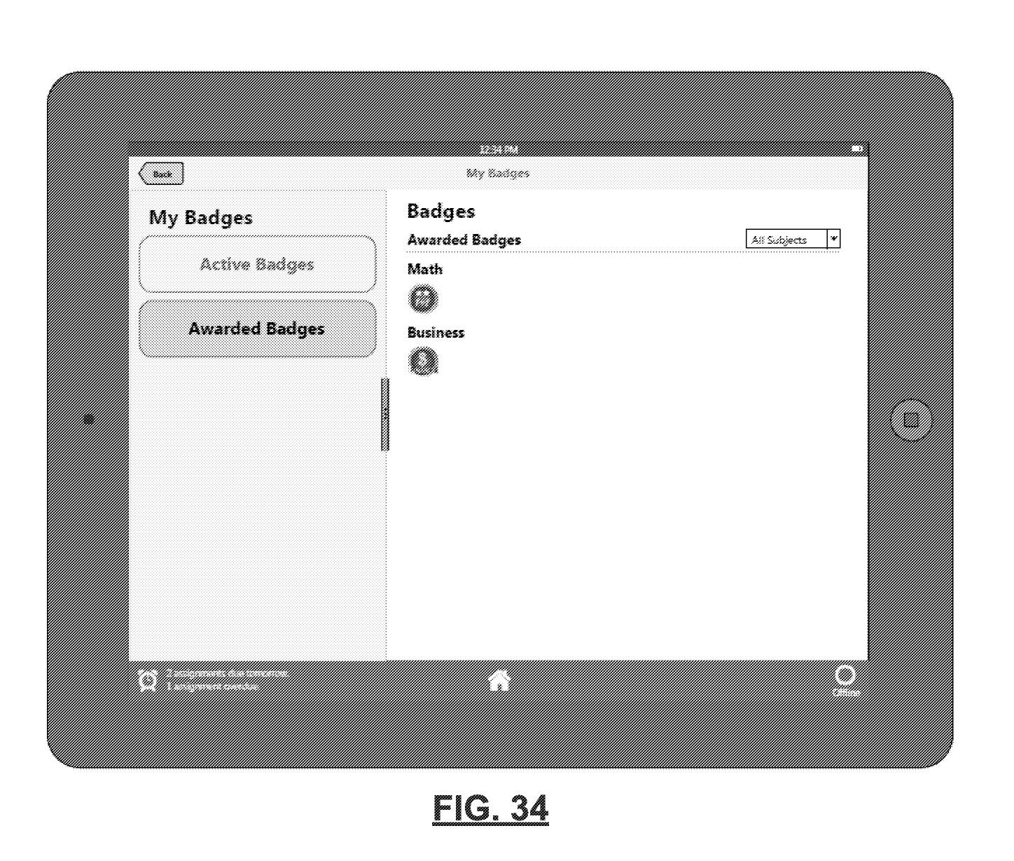

FIGS. 32-34 depict badge displays. Certain achievements can be rewarded with badges. Badges can be awarded for completion of certain tasks, scores on assessments above given thresholds, completion of courses, or otherwise. Badges can be provided as rewards, and in one embodiment, achievement of a badge can be a prerequisite for performance of other activities. Badges can be automatically rewarded by a learning management system based on certain predefined criteria, or badges can be awarded via instructor input (e.g., a student of the month badge). FIG. 32 depicts a graphical user interface showing current badges that a student is working towards, along with a progress bar associated with each badge. FIG. 33A depicts a badge detail display indicating steps that must be performed to achieve badge progress as well as current badge progress. FIG. 33B depicts an alternative display for current badge progress, where statuses for a number of badges associated with an algebra class are simultaneously displayed. FIG. 34 depicts a display of awarded badges.

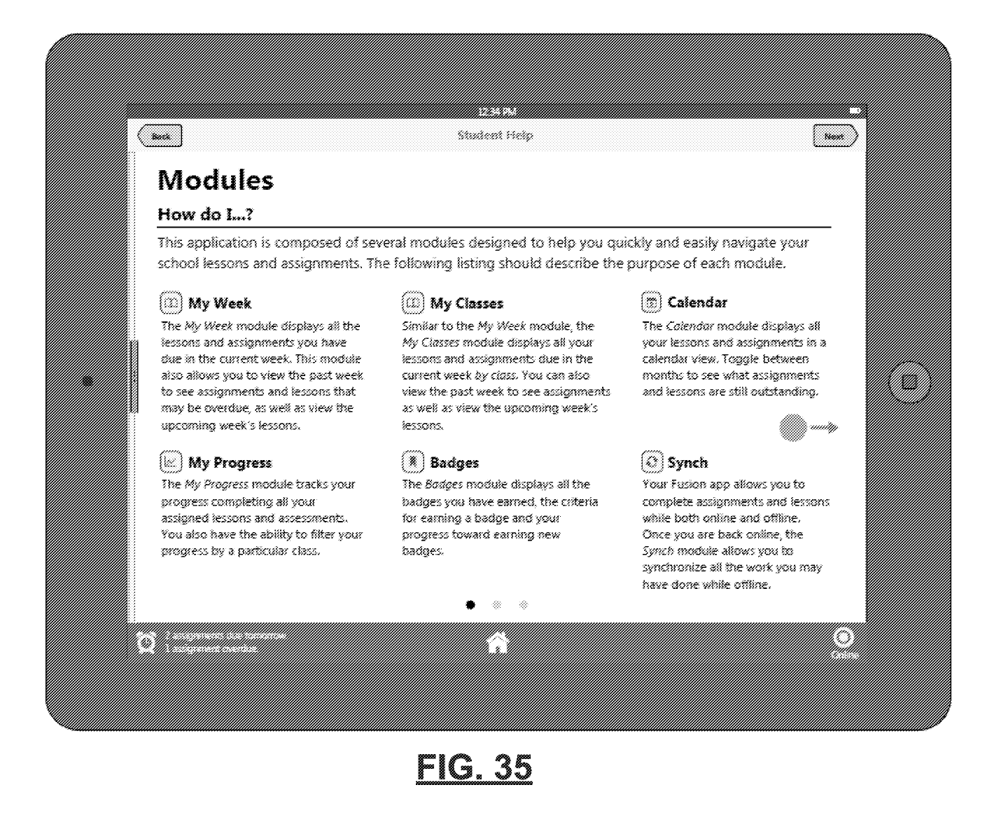

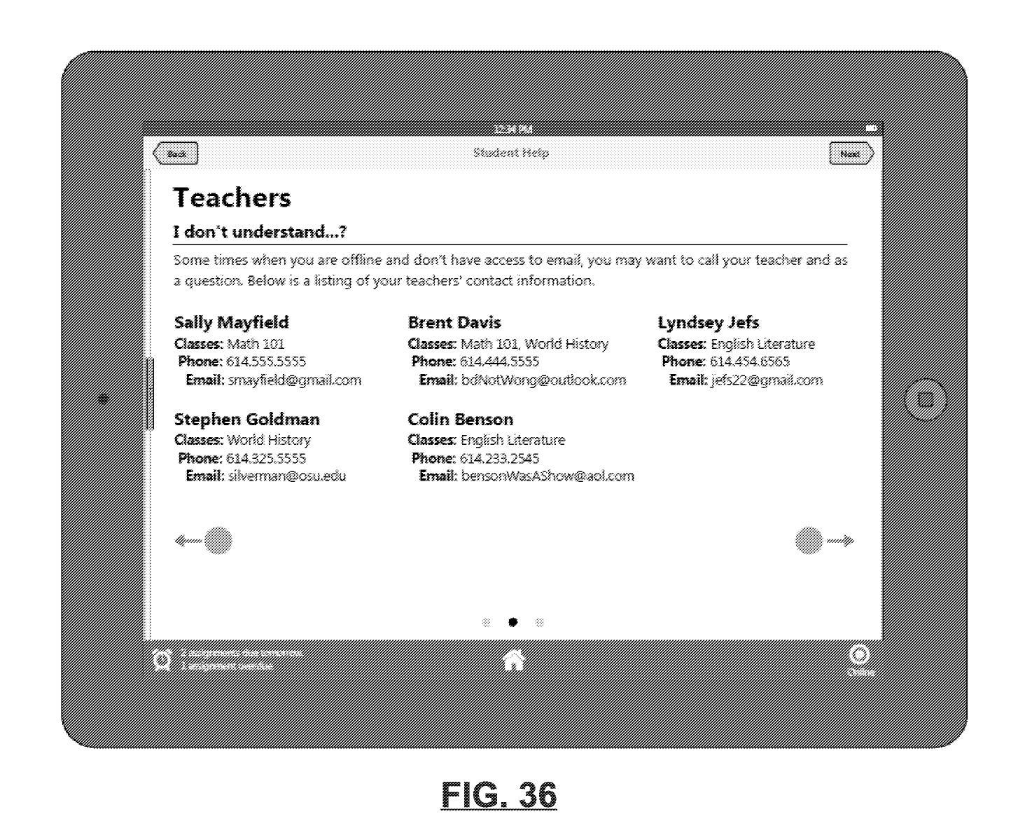

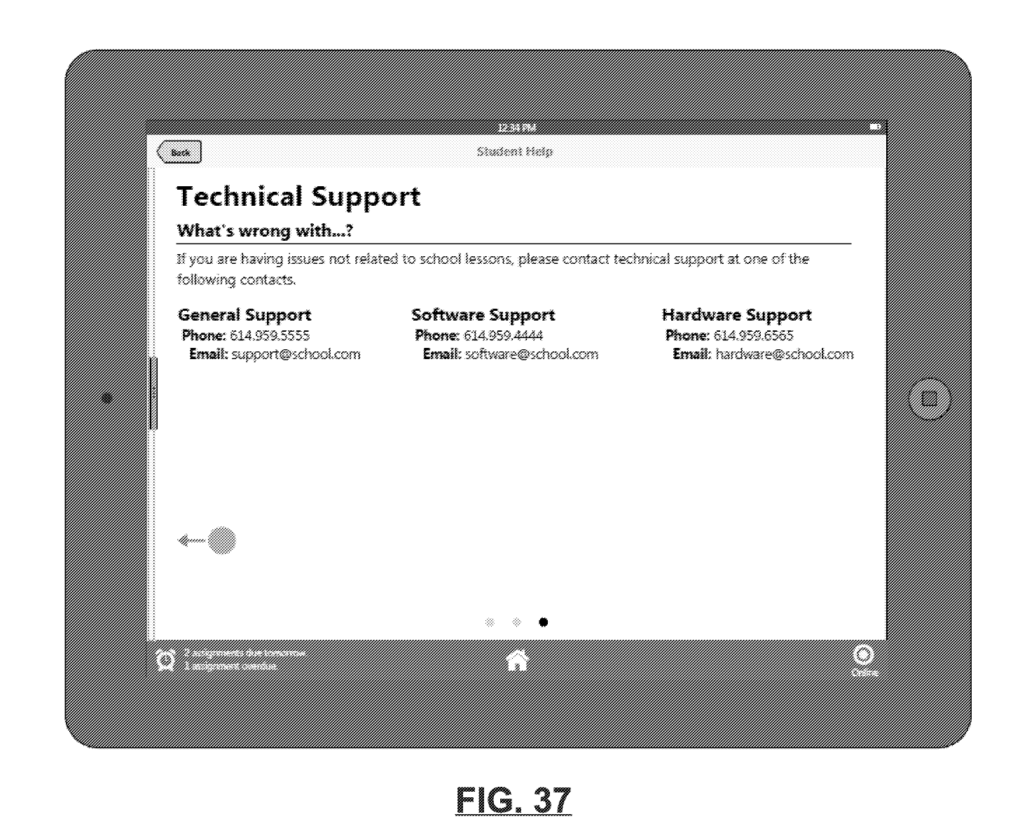

A learning management system can provide other displays for aiding a student in performing learning tasks. FIG. 35 depicts a help screen, where a student can access instructions for interacting with the learning management system. FIG. 36 depicts a teacher content page that includes information for contacting teachers of classes with which the student is associated. FIG. 37 depicts a technical support contact page.

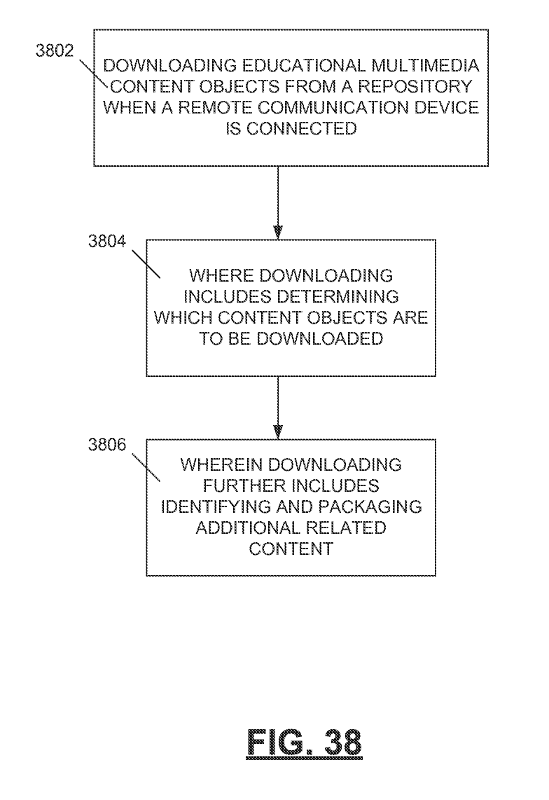

FIG. 38 is a flow diagram depicting a computer-implemented method of synchronizing educational multimedia content objects between a server system and a plurality of remote mobile communication devices over a network. At 3802, one or more educational multimedia content objects are downloaded to one of a plurality of remote communication devices from an educational multimedia repository provided on one or more non-transitory computer-readable mediums of a computer server system, where the downloading occurs while the one of the remote communication devices has a data connection with the computer server system. As depicted at 3804, downloading includes determining which of the educational multimedia content objects are to be downloaded to a specific remote mobile communication device based upon an educational standard or a teacher preference. As shown at 3806, downloading further includes analyzing educational content interdependencies that exist for a file to be downloaded to the specific remote mobile communication device to identify additional content to download for offline consumption, analyzing being based on an educational standard, a teacher preference, or external related content required by the file to operate on the specific remote mobile communication device while the specific remote mobile communication device is offline.

This application uses examples to illustrate the invention. The patentable scope of the invention includes other examples. For example, the incoming signal in other implementations may be a WiFi signal, a radio wave signal, a sonar signal, or any other electromagnetic signal.

It is claimed:

1. An educational multimedia system operating on a computer server system for synchronizing educational multimedia content objects between a server system and a plurality of remote mobile communication devices over a network, wherein the computer server system comprises one or more data processors, said system comprising:
an educational multimedia repository, provided on one or more non-transitory computer-readable mediums of the computer server system, for storing the educational multimedia content objects and making the educational multimedia content objects accessible to software components operating within the educational multimedia system;
instructions, executing on the computer server system, for downloading to one of the remote communication devices one or more of the educational multimedia content objects from the repository while the one of the remote communication devices has a data connection with the computer server system;
said instructions determining which of the educational multimedia content objects are to be downloaded to a specific remote mobile communication device based upon an educational standard or teacher preference;
educational content synchronization instructions, executing on the computer server system, for analyzing educational content interdependencies that exist for a file to be downloaded to the specific remote mobile communication device, said analyzing educational content interdependencies for the file being based upon the educational standard, the teacher preference, or external educational-related content required by the file to operate on the specific remote mobile communication device while the specific remote mobile communication device is offline.

2. The system of claim 1, wherein the educational multimedia content objects include PDF files, HTML files, audio files, video files, and others.

3. The system of claim 1, wherein the educational multimedia system issues within a blended school environment.

4. The system of claim 1, wherein the remote mobile communication devices include a tablet or a wireless mobile communication phone.

5. The system of claim 1, wherein the educational multimedia system includes a learning management system and assessment engine.

6. The system of claim 1, wherein the educational multimedia system includes hybrid technology that bridges use cases across student locations with and without Internet connectivity seamlessly.

7. The system of claim 1, wherein the educational multimedia system allows teachers to assign learning material to students based on unique needs of the individual students and class dynamics; wherein complementary content is retrieved and associated with the learning material based upon its relation to educational standards.

8. The system of claim 1, wherein the educational content synchronization instructions update learning content, assignments, quizzes, and assessments on the specific remote mobile communication device.

9. The system of claim 1, wherein the educational content synchronization instructions are configured to provide assessments and assignments that are due via multiple views, provide reminders about work due that day or work that is past due, provide progress indications via an intuitive visual guide, provide badges for work completed, and provide help for features within the mobile application.

10. The system of claim 1, wherein the specific remote mobile communication device includes a disconnected mobile application that when accessed without Internet connection, student activity, assignments completed, quizzes/test completed, activity within system, and supplemental materials accessed, are stored locally and are synchronized at a next online opportunity for teacher review, data processing, and analytics.

11. The system of claim 1, wherein the valve one or more of the educational multimedia content objects are checked with respect to digital rights management compliance before being downloaded to the remote mobile communication device.

12. The system of claim 1, wherein once a student has completed assignments and examinations, these are uploadable to the learning management system; wherein if the specific remote mobile communication device is not online, the completed assignments and examinations are cached; wherein if the specific remote mobile communication device is online, the completed assignments and examinations are uploaded and new content is downloaded for the student; wherein if the completed assignments and examinations can be auto-graded by the learning management system, the results of the assessment are made available to the student via the specific remote mobile communication device; wherein those items that must be graded by a teacher are reported to the specific remote mobile communication device during a future synchronization operation.

13. The system of claim 1, wherein the content that has been identified for the student and which does not already reside on the specific remote mobile communication device is gathered from the learning management system and learning object repository as HTML content, and the HTML content is downloaded to the specific remote mobile communication device.

14. The system of claim 13, wherein the HTML document is traversed so that the related links are gathered; based on said gathering, the documents for the related links are downloaded and placed into a same directory as the HTML document; wherein the HTML document is further traversed and all related links are replaced so as to use the directory.

15. The system of claim 14, wherein answer keys are removed from assessments, any dependent or related content is identified and collected and packaged into a compressed file before being downloaded to the specific remote communication device.

16. The system of claim 1 wherein the computer server system is implemented on a company server system or on a cloud-based server system or a combination thereof; where the company is the organization providing the services associated educational multimedia system.

17. A computer-implemented method of synchronizing educational multimedia content objects between a server system and a plurality of remote mobile communication devices over a network, comprising:
downloading to one of a plurality of remote communication devices one or more educational multimedia content objects from an educational multimedia repository provided on one or more non-transitory computer-readable mediums of a computer server system, the downloading occurring while the one of the remote communication devices has a data connection with the computer server system;
wherein said downloading includes determining which of the educational multimedia content objects are to be downloaded to a specific remote mobile communication device based upon an educational standard or a teacher preference; and
wherein said downloading further includes analyzing educational content interdependencies that exist for a file to be downloaded to the specific remote mobile communication device to identify additional content to download for offline consumption, said analyzing being based on an educational standard, a teacher preference, or external related content required by the file to operate on the specific remote mobile communication device while the specific remote mobile communication device is offline.

18. The method of claim 17, wherein specification of the teacher preference enables teachers to assign learning material to students based on unique needs of the individual students and class dynamics; wherein complementary content is retrieved and associated with the learning material based upon its relation to educational standards.

19. The method of claim 17, wherein the educational multimedia content objects include learning content, assignments, quizzes, and assessments.

20. The system of claim 17, wherein the specific remote mobile communication device is configured to provide assessments and assignments that are due via multiple views, provide reminders about work due that day or work that is past due, provide progress indications via an intuitive visual guide, provide badges for work completed, and provide help for features within the mobile application.
